(19) United States
(12) Patent Application Publication
(10) Pub. No.: US 2012/0079063 A1
(43) Pub. Date: Mar. 29, 2012

(54) METHOD, APPARATUS AND SYSTEM FOR PROVIDING EVENT NOTIFICATIONS ACROSS A PLURALITY OF COMPUTERS

(75) Inventors: Michael Stephen BROWN, Kitchener (CA); Herbert Anthony LITTLE, Waterloo (CA); Terrill Mark DENT, Waterloo (CA)

(73) Assignee: RESEARCH IN MOTION LIMITED, Waterloo (CA)

(21) Appl. No.: 13/218,138

(22) Filed: Aug. 25, 2011

Related U.S. Application Data
(60) Provisional application No. 61/386,806, filed on Sep. 27, 2010.

(51) Int. Cl. G06F 15/16

(52) U.S. Cl. 709/217

(57) ABSTRACT

A method, apparatus and system for providing an event notification across a plurality of computers is provided. In one aspect, a client machine and a mobile computing device are provided. The client machine is configured to execute a browser application. The mobile computing device is configured to host a web server application. When the client machine and the mobile computing device are connected, functions on the mobile computing device become available on the client machine via the interaction between the web server and the browser. Further, events received at the mobile computing device are sent to the client machine in response to periodic requests from the client machine.

### CROSS REFERENCE TO RELATED APPLICATION

This application claims the benefit of U.S. Provisional Application No. 61/386,806, filed Sep. 27, 2010, the entire content of which is hereby expressly incorporated by reference.

### FIELD

The present specification relates generally to computing devices and more particular relates to a method, apparatus, and system for providing event notifications across a plurality of computers.

### BACKGROUND

The evolution of computers is currently quite active in the mobile device environment. It is now well-known to include calendaring, contacts, and messaging functions in mobile devices. More recently, there has been a veritable explosion of the number and type of applications that are configured to the unique form factors and computing environments of mobile devices.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 is a schematic representation of a system for accessing an application across a plurality of computers.

FIG. 2 is a representation of a front view of the mobile computing device of the system of FIG. 1.

FIG. 3 is a block diagram of the device shown in FIG. 1.

FIG. 4 is a representation of a variation of the mobile computing device of FIG. 1.

FIG. 5 is a block diagram showing a non-limiting example of the host application in FIG. 3.

FIG. 6 is a flow-chart depicting a method of installing a proxy application.

FIG. 7 shows an example of the system of FIG. 1 after installation of the proxy application according to the method of FIG. 6, using a variation of the block diagram in FIG. 5.

FIG. 8 shows a method of accessing an application across a plurality of computers.

FIG. 9 shows the client machine and device of FIG. 1 in isolation and in greater detail to illustrate an example of performance of certain blocks from the method of FIG. 8.

FIG. 10 shows the client machine and device of FIG. 9 to illustrate another example of performance of certain blocks from the method of FIG. 8.

FIG. 11 shows the client machine and device of FIG. 9 to illustrate another example of performance of certain blocks from the method of FIG. 8.

FIG. 12 is a schematic representation of a system for providing event notifications across a plurality of computers.

FIG. 13 is a block diagram showing a non-limiting example of a variation of the host application in FIG. 5 for incorporation into the system of FIG. 12.

FIG. 14 is a flow-chart depicting a method of providing event notifications across a plurality of computers.

FIG. 15 shows the client machine and device of FIG. 12 to illustrate example performance of certain blocks of the method of FIG. 14.

FIG. 16 shows the client machine and device of FIG. 12 to illustrate example performance of certain blocks of the method of FIG. 14.

FIG. 17 shows the client machine and device of FIG. 12 to illustrate example performance of certain blocks of the method of FIG. 14.

FIG. 18 shows the client machine and device of FIG. 12 to illustrate example performance of certain blocks of the method of FIG. 14.

FIG. 19 is a schematic representation of a system for providing event notifications across a plurality of computers.

FIG. 20 is a block diagram showing a non-limiting example of a variation of the host application in FIG. 13 for incorporation into the system of FIG. 19.

FIG. 21 shows the client machine and device of FIG. 19 in isolation and in greater detail to illustrate an example of operation.

FIG. 22 is a flow-chart depicting another method of providing event notifications across a plurality of computers.

FIG. 23 is a flow-chart depicting another method of providing event notifications across a plurality of computers.

FIG. 24 is a flow-chart depicting another method of providing event notifications across a plurality of computers.

FIG. 25 shows the client machine and device of FIG. 19 in isolation and in greater detail to illustrate an example of performance of providing event notifications across a plurality of computers.

FIG. 26 shows the client machine and device of FIG. 19 in isolation and in greater detail to illustrate an example of performance of providing event notifications across a plurality of computers.

FIG. 27 shows the client machine and device of FIG. 19 in isolation and in greater detail to illustrate an example of performance of providing event notifications across a plurality of computers.

FIG. 28 shows the client machine and device of FIG. 19 in isolation and in greater detail to illustrate an example of performance of providing event notifications across a plurality of computers.

FIG. 29 shows the client machine and device of FIG. 19 in isolation and in greater detail to illustrate an example of performance of providing event notifications across a plurality of computers.

FIG. 30 shows the client machine and device of FIG. 19 in isolation and in greater detail to illustrate an example of performance of providing event notifications across a plurality of computers.

### DETAILED DESCRIPTION

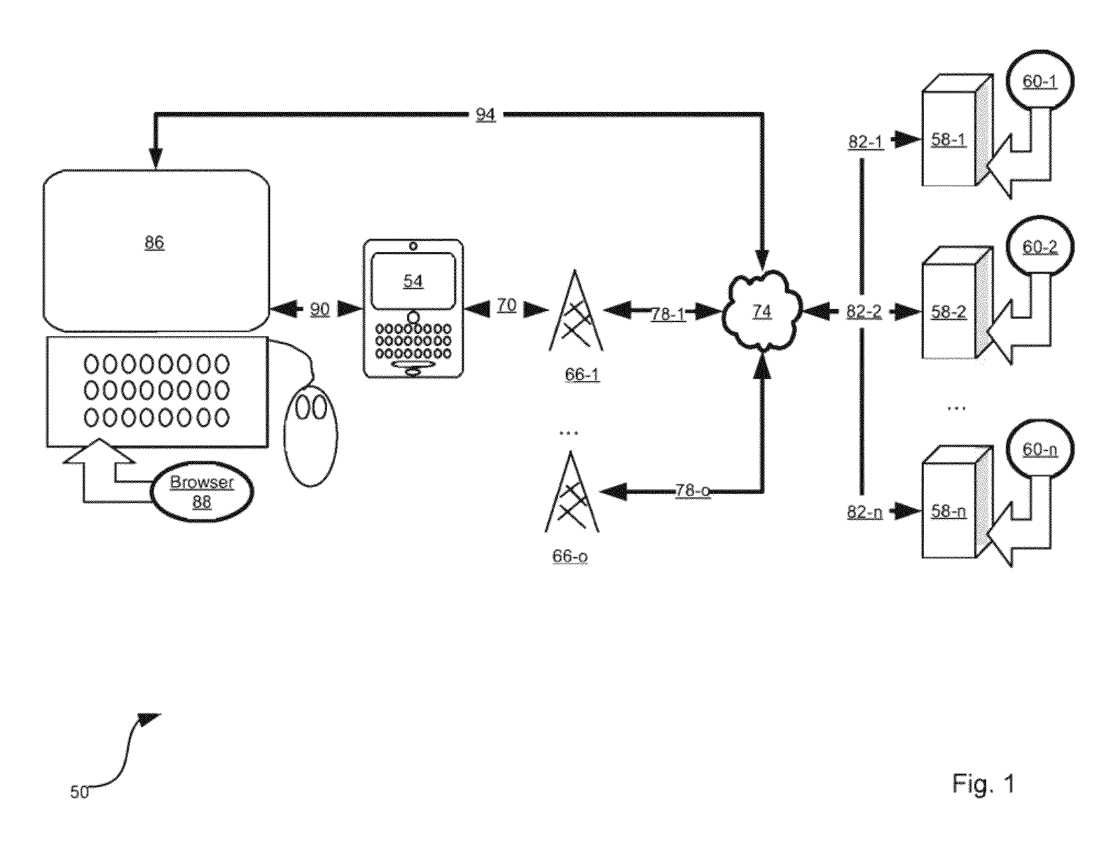

Referring now to FIG. 1, a system for accessing an application across a plurality of computers is indicated generally at 50. In a present embodiment system 50 comprises at least one computing device in the form of a mobile computing device 54 and at least one server 58-1, 58-2 . . . 58-n. (The nomenclature of server 58, and collectively, servers 58 are used generically throughout this document).

A wireless link 70 connects mobile computing device 54 with one of a plurality of wireless base stations 66. In FIG. 1, mobile computing device 54 is shown as connecting to a first base station 66-1 via wireless link 70, but mobile computing device 54 can also connect to other base stations 66 in system 50. Backhaul links 78 connect each base station 66 to a network 74. Additional backhaul links 82 connect network 74 to each server 58.

Mobile computing device 54 can be any type of electronic device that can be used in a self-contained manner and to interact with content available on network 74. Interaction includes displaying of information on mobile computing device 54 as well as to receive input at mobile computing device 54 that can in turn be sent back over network 74. Mobile computing device 54 will be explained in greater detail below.

It should now be understood that the nature of network 74 and links 70, 78, and 82 associated therewith is not particularly limited and are, in general, based on any combination of architectures that will support interactions between mobile computing device 54 and servers 58. In a present embodiment network 74 includes the Internet as well as appropriate gateways and backhauls to links 78 and 82. For example, backhaul links 78 and backhaul links 82 can be based on a T1, T3, O3, or any other suitable wired or wireless connections. Accordingly, the links 78 and 82 between network 74 and the interconnected components are complementary to functional requirements of those components.

Link 70 may be based on, by way of non-limiting examples, a core mobile network infrastructure, such as, by way of non-limiting examples, one or more of Global System for Mobile communications (“GSM”); Code Division Multiple Access (“CDMA”); CDMA 2000;) 3G; or Evolution-Data Optimized or Evolution-Data (“EVDO”); or successors thereto or hybrids or combinations thereof; or on a wireless local area network (“WLAN”) infrastructures such as, by way of non-limiting examples, the Institute for Electrical and Electronic Engineers (“IEEE”) 802.11 Standard (and its variants) or Bluetooth or the like or hybrids or combinations thereof. Note that in an example variation of system 50 it is contemplated that link 70 may be a wired connection.

A client machine 86 also connects to mobile computing device 54 via a link 90. In a present example implementation, client machine 86 is a desktop, notebook, laptop, or tablet computer and link 90 is a direct connection effected wirelessly or wired. Where link 90 is wireless, then link 90 can be, for example, a Bluetooth™ or a peer-to-peer Wi-Fi connection between client machine 86 and mobile computing device 54. Where link 90 is wired, then link 90 can be, for example, a universal serial bus (USB) or Firewire connection. Those skilled in the art will now recognize other types of wired or wireless connections that can be used to effect a direct connection for link 90. In variations, link 90 can be effected indirectly through, for example, a local area network or a Wi-Fi network, or even through a wide area network such as network 74.

Client machine 86 is initially configured to maintain or execute at least a web browser application 88, and need not have direct access to network 74, though in some cases such a direct connection to network 74 would be possible through a link 94. Accordingly, client machine 86 can be based on any computing environment that provides web browsing functionality. For example, such a computing environment can be based on an Intel™ or AMD™ or other microprocessor, with accompanying volatile storage (e.g. random access memory) and non-volatile storage (e.g. Flash, Hard disc drive), read only memory (ROM), network interface card(s), video cards that connect to one or more displays, a keyboard, a mouse (or other pointing device). Any operating system may be used, including, for example, an operating system offered by Microsoft™, or a Linux™ operating system, or an operating system offered by Apple Computer, or an operating system offered by QNX. Browser application 86 can be any browser application that is executable on a respective operating system, including Firefox™, Internet Explorer™, Chrome™, Opera™ or Safari™. Typically, though not necessarily, client machine 86 will have a display or a keyboard or both that are larger than that provided on mobile computing device 54. Client machine 86 may also have another configuration, such as a tablet computing device.

Servers 58 can be based on any well-known server environment including a module that houses one or more central processing units, volatile memory (e.g. random access memory), persistent memory (e.g. hard disk devices), and network interfaces to allow servers 58 to communicate over network 74. For example, each server 58 can be a ProLiant® Server from Hewlett-Packard Company, 3000 Hanover Street Palo Alto, Calif. 94304-1185 USA having a plurality of central processing units and having several gigabytes of random access memory. However, it is to be emphasized that this particular server is merely a non-limiting example, and a vast array of other types of computing environments for each server 58 is contemplated. Furthermore, it is contemplated that each server 58 may be implemented as a plurality of interconnected servers, in a so-called server farm, which are mirrored or otherwise configured for load balancing or failover or high availability or any or all of those.

As will be discussed further below, each server 58 maintains a different networking application 60. Networking applications 60 can be any application whereby a corresponding client-side application executes on mobile computing device 54 which accesses data or any other server functions on a given server 58. Networking applications can be, by way of non-limiting examples, personal information management applications, social networking applications, or messaging applications. Non-limiting examples of personal information management applications include calendaring and contact management applications. Non-limiting examples of social networking application 60 include Facebook™, Twitter™, LinkedIn™, and MySpace™. Networking applications 60 can also comprise message applications such email, BlackBerry Messenger, AOL instant messenger (AIM), Yahoo Messenger (YM), Google Talk (Gtalk), Lotus Connections, Windows Live Messenger. There are many others.

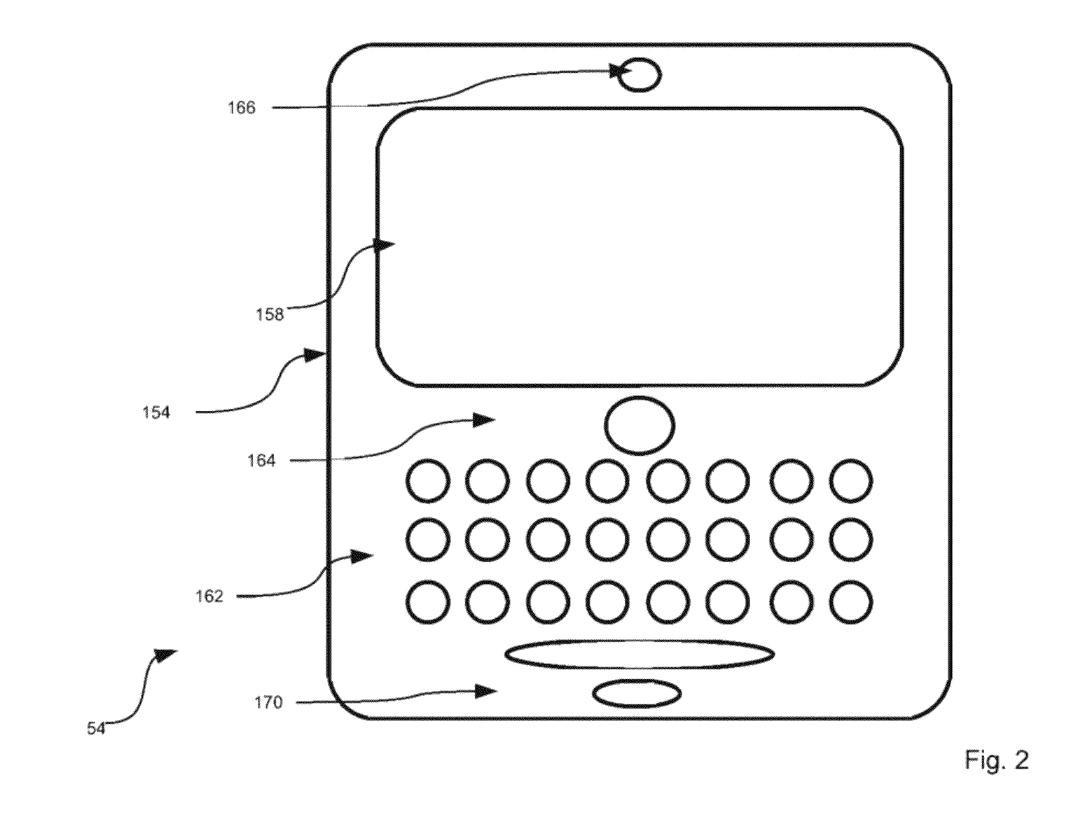

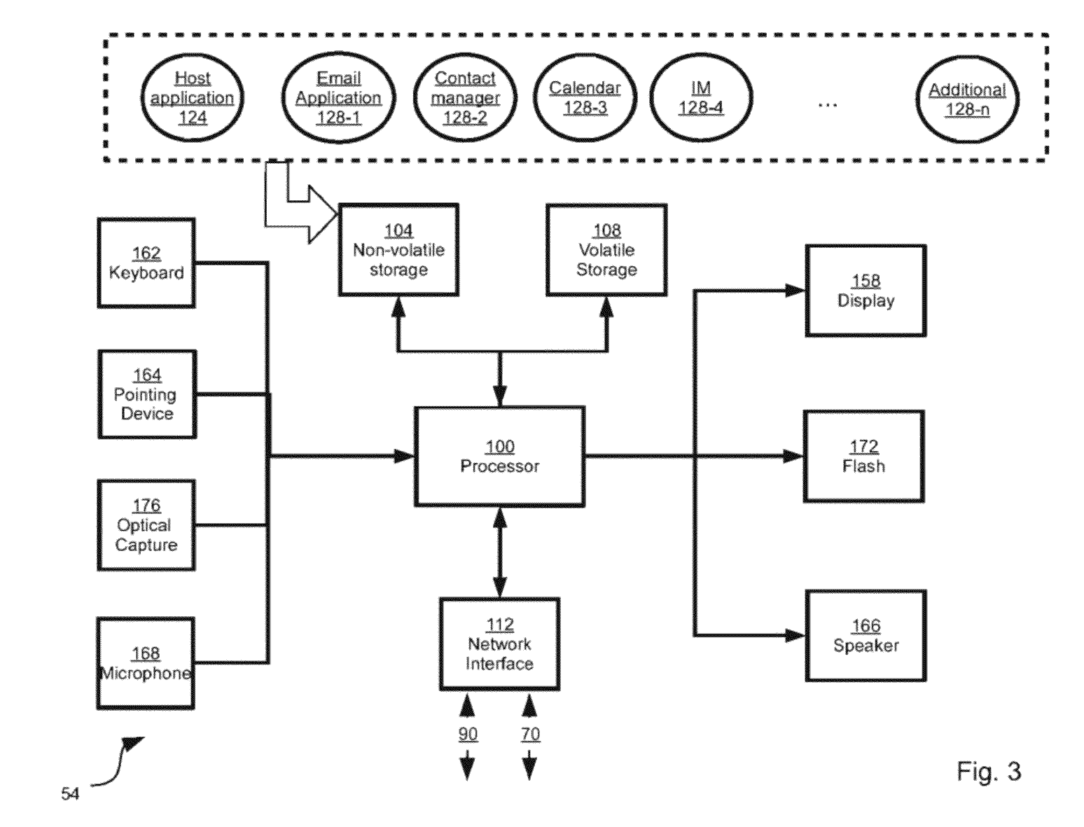

FIG. 2 and FIG. 3 show different views and representations of a non-limiting example of a mobile computing device 54 which can execute one or more applications as discussed in greater detail below. It is to be understood that mobile computing device 54 is an example, and it will be apparent to those skilled in the art that a variety of different portable electronic device structures are contemplated. Indeed variations on mobile computing device 54 can include, without limitation, a cellular telephone, a portable email paging device, a network enabled digital camera, a portable music player, a portable video player, a portable video game player.

Referring to FIG. 2, in a present, non-limiting example, device 54 comprises a chassis 154 that supports a display 158. Display 158 can comprise one or more light emitters such as an array of light emitting diodes (LED), liquid crystals, plasma cells, or organic light emitting diodes (OLED). Other types of light emitters are contemplated. Chassis 154 also support a keyboard 162. It is to be understood that this specification is not limited to any particular structure, spacing, pitch, or shape of keyboard 162, and the depiction in FIG. 2 is an example. For example, full or reduced “QWERTY” keyboards are contemplated. Other types of keyboards are contemplated. (In variations, device 54 may also be a touch-screen device with no physical keyboard.) Device 54 also comprises a pointing device 164 which can be implemented as a touch-pad, joystick, trackball, track-wheel, or as a touch sensitive membrane on display 158. Device 54 may also comprise a speaker 166 for generating audio output, and a microphone 68 for receiving audio input.

FIG. 3 shows a schematic block diagram of the electronic components of device 54. It should be emphasized that the structure in FIG. 3 is an example. Device 54 includes a plurality of input devices which in a present embodiment includes keyboard 162, pointing device 64, and microphone 168 and an optical capture unit 176. Fewer, additional, or alternative input devices are contemplated. Input from keyboard 162, pointing device 164 and microphone 168 and optical capture unit 176 is received at a processor 100. Processor 100 can be configured to execute different programming instructions that can be responsive to the input received via input devices. To fulfill its programming functions, processor 100 is also configured to communicate with a non-volatile storage unit 104 (e.g. Erase Electronic Programmable Read Only Memory (“EEPROM”), Flash Memory) and a volatile storage unit 108 (e.g. random access memory (“RAM”)). Programming instructions that implement the functional teachings of device 54 as described herein are typically maintained, persistently, in non-volatile storage unit 104 and used by processor 100 which makes appropriate utilization of volatile storage 108 during the execution of such programming instructions.

Processor 100 in turn is also configured to control display 158, speaker 166 and flash 172, also in accordance with different programming instructions and optionally responsive to different input receive from the input devices. Fewer, additional, or alternative output devices are contemplated.

Processor 100 also connects to a network interface 112, which can be implemented in a present embodiment as one or more radios configured to communicate over link 70 and link 90. Network interface 112 can thus be generalized as a further input/output device that can be utilized by processor 100 to fulfill various programming instructions. It will be understood that interface 112 is configured to correspond with the network architecture that defines each link 70 and link 90. It is also contemplated each network interface 112 can include multiple radios to accommodate the different protocols that may be used to implement different types of links where the network architecture for each link 70 differs between base stations 66, or where link 90 may be based on different architectures. For example, link 90 may also be a wired link (e.g. USB) in which case it may not have a radio at all.

In a present embodiment, device 54 is also configured to maintain, within non-volatile storage 104, a host application 124, and one or more client applications 128 such as an email application 128-1, a contact manager application 128-2, a calendar application 128-3, an instant messenger application 128-4 or one or more of a plurality of additional applications 128-n. Non-limiting examples of additional applications 128 can comprise, without limitation, one or more of social networking client applications, e.g., Twitter, Facebook, MySpace, LinkedIn; other applications associated with online communities e.g., Flickr, Gtalk, etc; document tools such as Google Docs. Any one or more of host application 124 and client applications 128 can be pre-stored in non-volatile storage 104 upon manufacture of device 54, or downloaded via network interface 112 and saved on non-volatile storage 104 at any time subsequent to manufacture of device 54. Each application 128 is also configured to interact with its corresponding network application 60 as needed.

Processor 100 is configured to execute each application 128, making use of input from input devices and controlling display 158 to generate output based on that input and according to the programming instructions of each application 128. In general, each application 128 can be based on any existing or future application 128 that can be executed entirely on a device such as device 54, even when link 90 is not active and device 54 is disconnected from client machine 86. For example, email application 54 can be a standard electronic mail application that is already commonly deployed on various devices such as device 54 and entirely usable on device 54, without any connection to client machine 86, and while accessing servers 58 as needed. Likewise contact manager application 128-2, calendar application 128-3, instant messenger application 128-4 and any of the additional applications 128-n can be based on such applications that are already commonly deployed, or may be deployed in the future, and entirely usable on device 54 without any connection to client machine 86, and while accessing servers 58 as needed.

Processor 100 is also configured to execute host application 124 to permit access to client applications 128 via client machine 86, when link 90 is active, as will be explained further below.

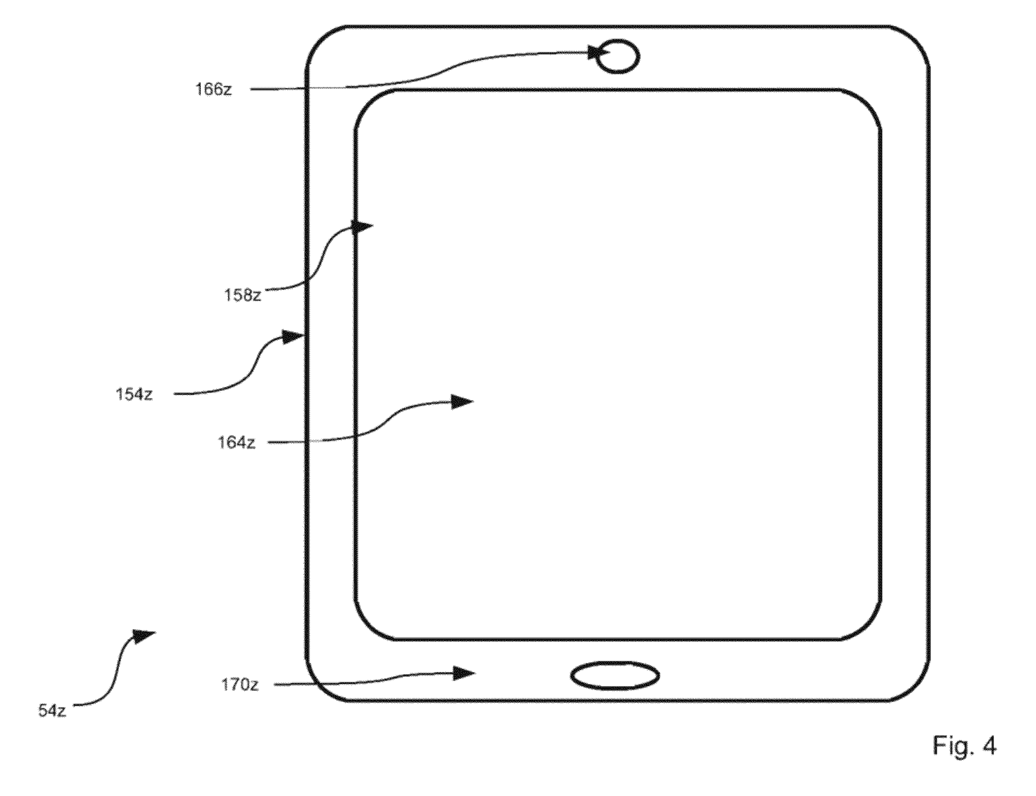

Referring briefly to FIG. 4, a variation on device 54 is indicated generally as device 54z. Device 54z comprises many of the same components as device 54, and therefore like components bear like references except followed by the suffix “z”. Of note is that device 54z excludes keyboard 162 and pointing device 164. Instead, device 54z comprises a touch screen 164z which provides the combined functionality of keyboard 162 and pointing device 164. Further variations on device 54 will now occur to those skilled in the art, but for convenience, further discussion of the present specification will focus on device 54 as described above. As will become apparent from further discussion herein, the lack of a full keyboard in device 54z presents certain limitations for providing input to device 54z, and those limitations may be mitigated by the present specification.

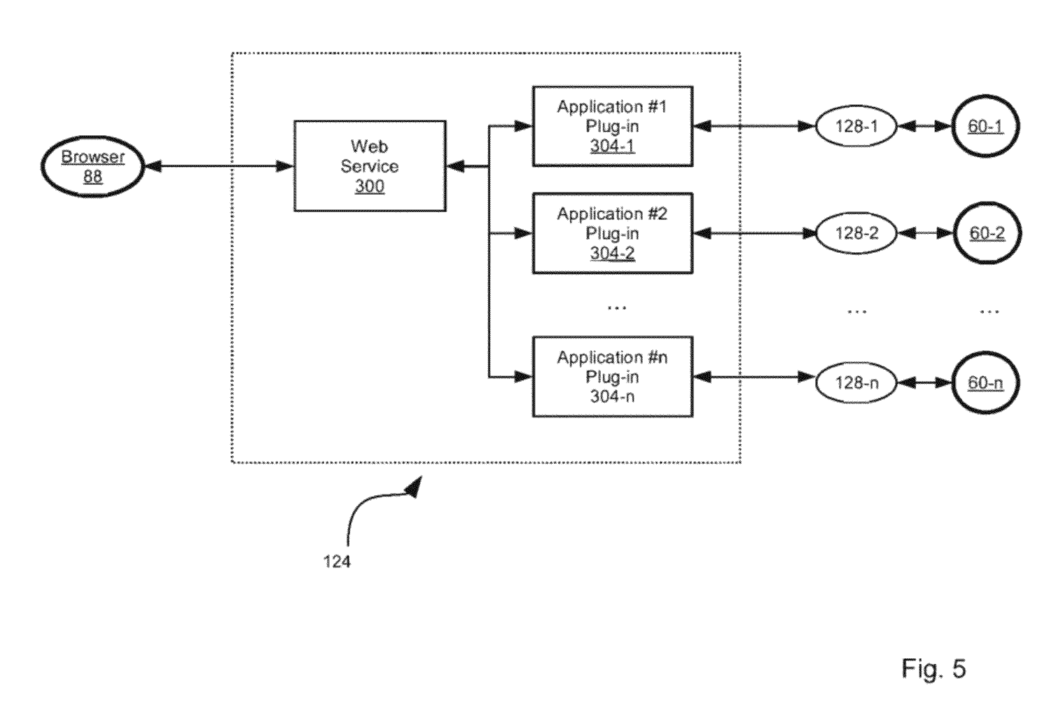

FIG. 5 shows a block diagram of an example implementation of host application 124 and its virtual connections to browser 88 and applications 128. Virtual connections between applications 128 and applications 60 are also shown. Those skilled in the art will now recognize that the components and connections in FIG. 5 can be implemented using the hardware structures shown in FIG. 1, or variations thereon. Host application 124 thus comprises a web service 300 and a plurality of application plug-ins 304. Web service 300 is configured to generate and serve content to browser 88, on behalf of each application 128 via respective application plug-ins 304. Application plug-ins 304 is configured to act as programming interfaces between web service 300 and applications 128. Accordingly, each application plug-in 304 is uniquely configured for its corresponding application 128, so that web service 300 can generate hyper-text markup language (HTML), as desired, and any other code (e.g. JavaScript files, Cascading Style Sheets) that are usable by browser 88, so that graphical interfaces can be generated on client machine 86 for each application 128. According to this implementation, no modification to each application 128 is needed in order to provide access to those applications 128 via browser 88. Instead, access to a particular application 128 can be provided on browser 88 by creating a plug-in 304 for that particular application 128. Alternatively, a plug-in 304 may be implemented as a component of a particular application 128.

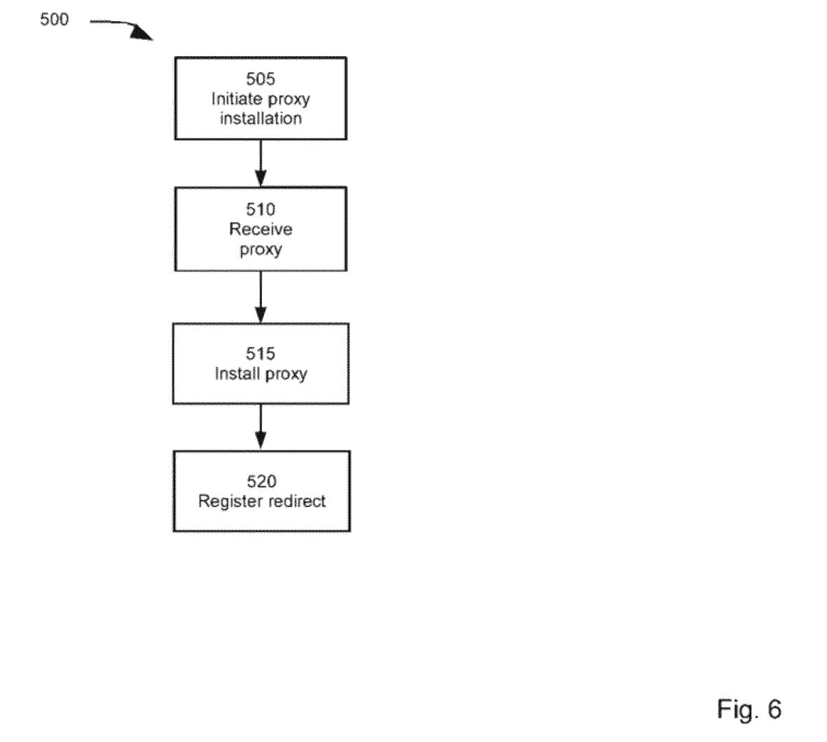

Referring now to FIG. 6, a flow-chart depicting a method for provisioning a client machine to interact with a mobile electronic device is indicated generally at 500. Method 500 can be implemented using system 50, and for purposes of explaining method 500 it will be assumed that method 500 is performed using system 50. However, it is to be understood that variations are contemplated to both method 500 and system 50 and such variations are within the scope of this specification. Method 500 is not strictly required, but in a present implementation method 500 provides a proxy on client machine 86 such that web service 300 is addressable and reachable from the address bar in browser 88. Method 500 also assumes that link 90 is a direct link between client machine 86 and mobile electronic device 54. Again, such a direct connection for link 90 can be a peer-to-peer Bluetooth™ connection whereby client machine 86 and device 54 are “paired” using known Bluetooth™ hardware and network protocols. Such a direct connection for link 90 can also be a USB cable connection. Other means for implementing link 90 will now occur to those skilled in the art. In a present implementation, it is assumed that link 90 is a Bluetooth™ connection.

Block 505 comprises receiving an instruction to install a proxy application. Block 505 can be implemented in different ways. One factor that affects how block 505 is implemented is the location where the installation file for the proxy application is stored. In one implementation, the proxy application is stored on a server (possibly one or more of servers 58, though not necessarily) connected to network 74, in which case installation initiation may be effected by entering a uniform resource locator (URL) into browser 88 that points to the network 74 address of the server that stores the proxy application. In another implementation, the proxy application is stored as a data file within persistent storage 104 of device 54. In this implementation, non-volatile storage 104 of device 54 is configured to appear as an external hard-disk when link 90 is active—this type of configuration being inherent in many operating systems and devices such as device 54, where link 90 is a USB connection. Thus, once device 54 appears as a hard-disk, the data file containing the proxy application can be downloaded via link 90 onto client machine 86. In variations, the proxy could be provided on a CD or other removable media.

Block 510 comprises receiving the proxy application for which installation was initiated at block 505. Where proxy application is stored on network 74, then block 510 comprises downloading the proxy application via network 74 and link 94. When proxy application is stored on device 54, then the proxy application is transferred via link 90 to client machine 86.

Those skilled in the art will now recognize other means of effecting block 505 and block 510.

Block 515 comprises installing the proxy application that was received at block 510. At this point it will be appreciated that the form in which proxy application is originally stored and received can vary according to the level of sophistication to be employed in the actual installation of the proxy application. It is presently contemplated that the proxy application will be an executable application that invokes an installation wizard, or the like, so that a simple series of key strokes on client machine 86 are all that is required to actually install the proxy application. However, proxy application can be received at block 510 in other forms.

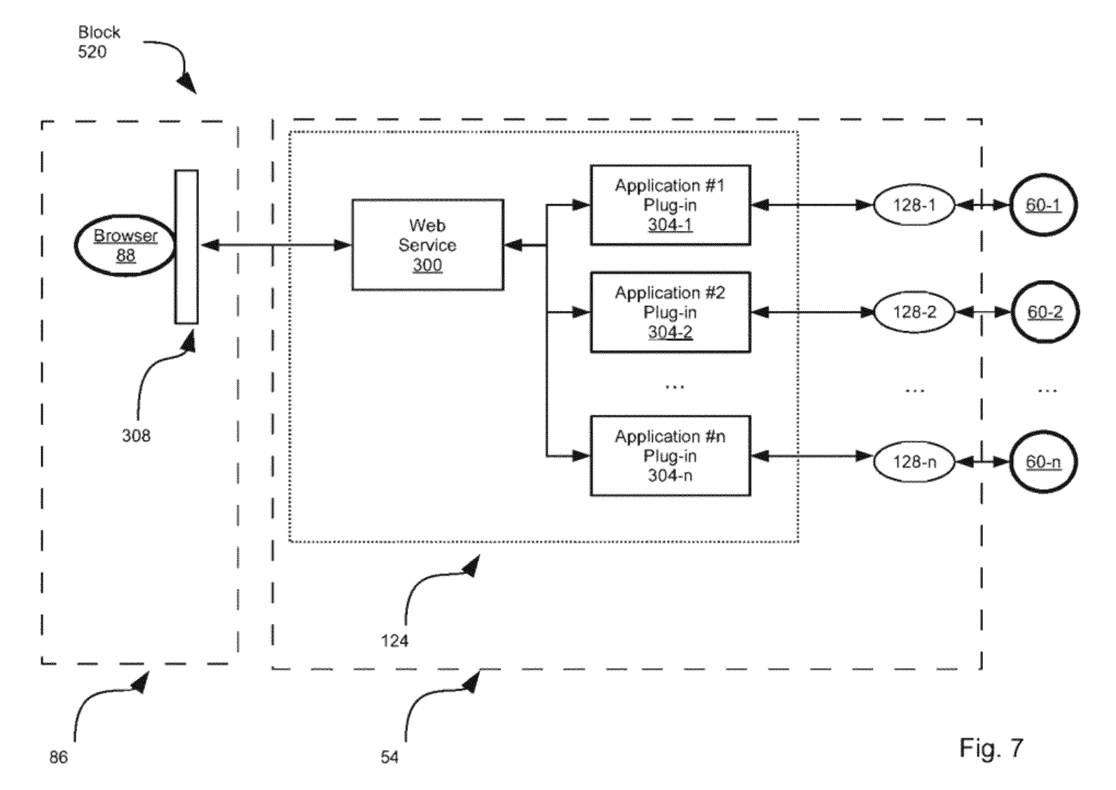

Block 520 comprises registering the proxy application installed at block 515. Such registration is local to the client machine and serves to identify a URL or Internet Protocol (IP) address redirect such that entry of that URL or IP addresses that causes browser 88 to access web service 300. A representation of portions of system 50 is shown in FIG. 7, which itself is a variation on FIG. 5. FIG. 7 is thus substantially the same as FIG. 5, except that a proxy application 308 is shown as being installed on client machine 86 and sitting between browser 88 and web service 300 on devices 54. Expressed another way, proxy application 308 configures client machine 86 so that entry of a given URL or other address in the address bar of browser 88 directs browser 88 to connect with web service 300 and to generate a web page on the display of client machine 86 that corresponds to a web page being offered by web service 300. The term “generate” should not be construed in a limiting sense, and refers to any control of the display by one or more processors in order to render the page on the display of the client. An example of such a URL may be, http://localhost, provided such a URL is not already reserved for another proxy application on client machine 86. Thus, upon entry of http://localhost, browser 88 will be directed to proxy 308 and in turn browser 88 will connect to web service 300. Returning to the example where link 90 is based on Bluetooth™, then proxy application 308 sits between browser 88 and the Bluetooth service and drivers executing on client machine 86, and forms a virtual connection with device 54 according to the Bluetooth pairing that has been registered on the Bluetooth service of device 54. In turn, web service 300 is configured to respond to HTTP requests received via the Bluetooth service that is resident on device 54.

At this point it is to be reiterated that method 500 and the use of proxy application 308 is not needed in all implementations contemplated by this specification, and accordingly, certain of the following discussions may not make reference to proxy application 308 and FIG. 7. However, it is also to be understood that the following discussion is also applicable to configurations that utilize proxy application 308. Also, in some configurations, the proxy application 308 may be pre-installed on client machine 86, so that method 500 may not be required.

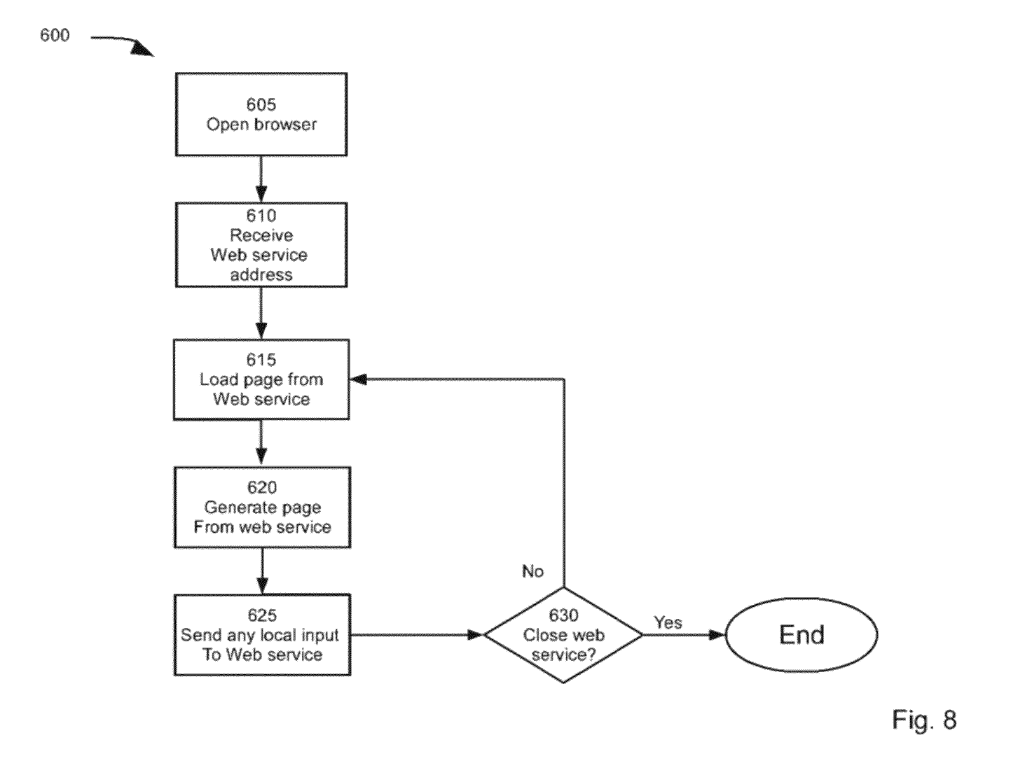

Referring now to FIG. 8, a flow-chart depicting a method for accessing an application across a plurality of computers is indicated generally at 600. Method 600 can be implemented using system 50, and for purposes of explaining method 600 it will be assumed that method 600 is performed using system 50. However, it is to be understood that variations are contemplated to both method 600 and system 50 and such variations are within the scope of this specification. Performance of method 600 presumes that link 90 is active between device 54 and client machine 86.

Block 605 comprises opening a web browser. In system 50, block 605 is effected at client machine 86 whereby browser 88 is opened in the usual manner. Block 610 comprises receiving a web services address. Block 610 is effected by typing an address (e.g. http://localhost) into the address bar of browser 88. In system 50, the address received at block 610 corresponds to the address web service 300 of host application 124. In variations, it is contemplated that system 50 may be configured so that browser 88 is automatically launched and directed to the appropriate address in a single step: for example via a desktop shortcut on client machine 86.

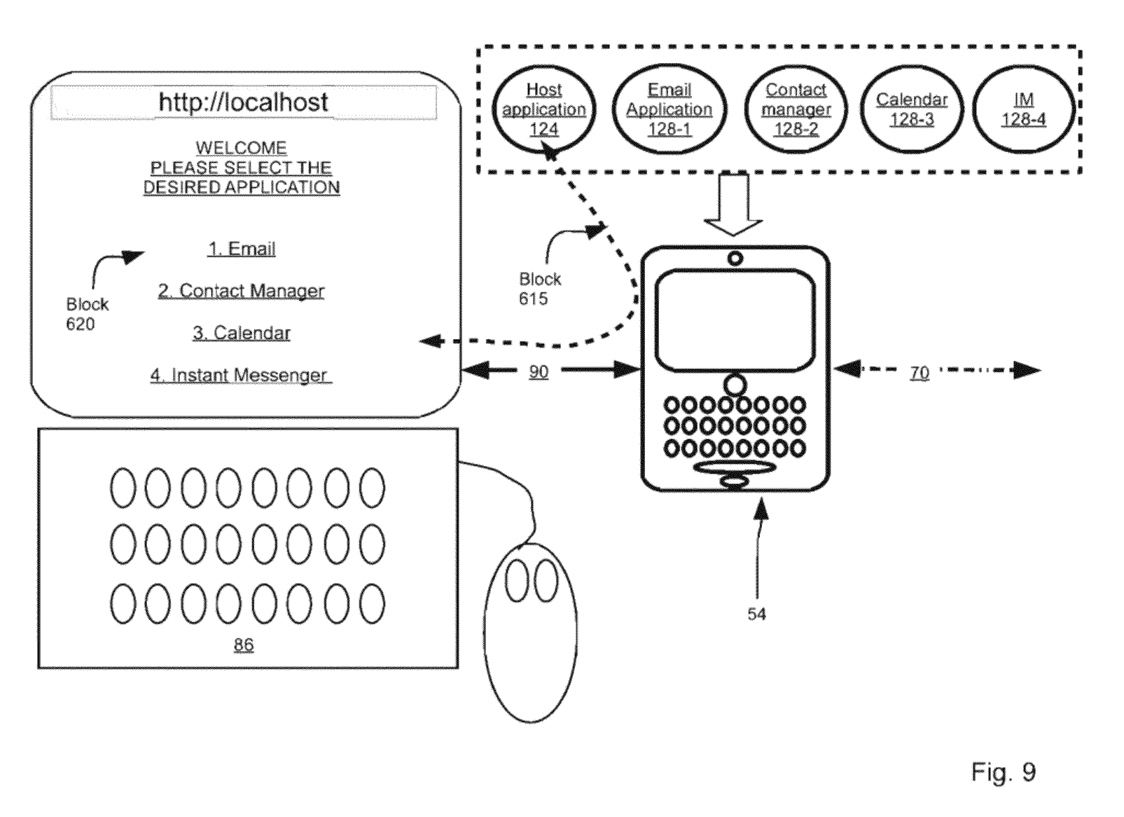

Block 615 comprises loading a web page from the web service. In system 50, and during the initial performance of block 615, block 615 can comprise loading a webpage in the form of a menu that can be used to select invocation of any one of applications 128. An example of performance of this initial performance of block 615 is shown in FIG. 9, where browser 88 is open on the display of client machine 86, and a URL pointing to the web service 300 of host application 124 is open. Block 620 comprises generating the web page that was loaded at block 615. As can be seen in FIG. 9, host application 124 is serving a menu web page, which offers web-based access to the applications 128 that are available on device 54. Thus, as shown on the display of client machine 86 in FIG. 9, menu item one reads “Email”, which is offering access to email application 128-1; menu item two reads “Contact Manager”, which is offering access to contact manager application 128-2; menu item three reads “Calendar”, which is offering access to contact manager application 128-3; and menu item four reads “Instant Messenger”, which is offering access to instant message application 128-4. For simplicity, application 128-n is not shown in FIG. 9.

Block 625 comprises sending any local input to the web service. Block 625 is affected through browser 88 which accepts local input from the keyboard or the mouse that is connected to client machine 86. As part of that locally received input, any input that is responsive to forms or links or other input that can be entered into the page generated at block 620 is sent to the web service that originally served the page generated at block 620.

According to the example in FIG. 9, input can be received that selects one of the four menu items being generated on the display of client machine 86. To give a specific example, it can be assumed that menu item one is selected, indicating an instruction to access email application 128-1. Again, such selection can be effected via keyboard input, or by bringing a cursor into focus over the desired selection using a mouse, and then clicking the mouse to effect the selection, or via touch-screen input by touching the desired selection.

Block 630 comprises determining whether an instruction has been received to close the web service. Such an determination can be based on closing browser 88, or it can be based on entry of another URL in the address bar of browser 88, or it can based on any other instruction or event that instructs closing of the web service. A “yes” determination ends method 600.

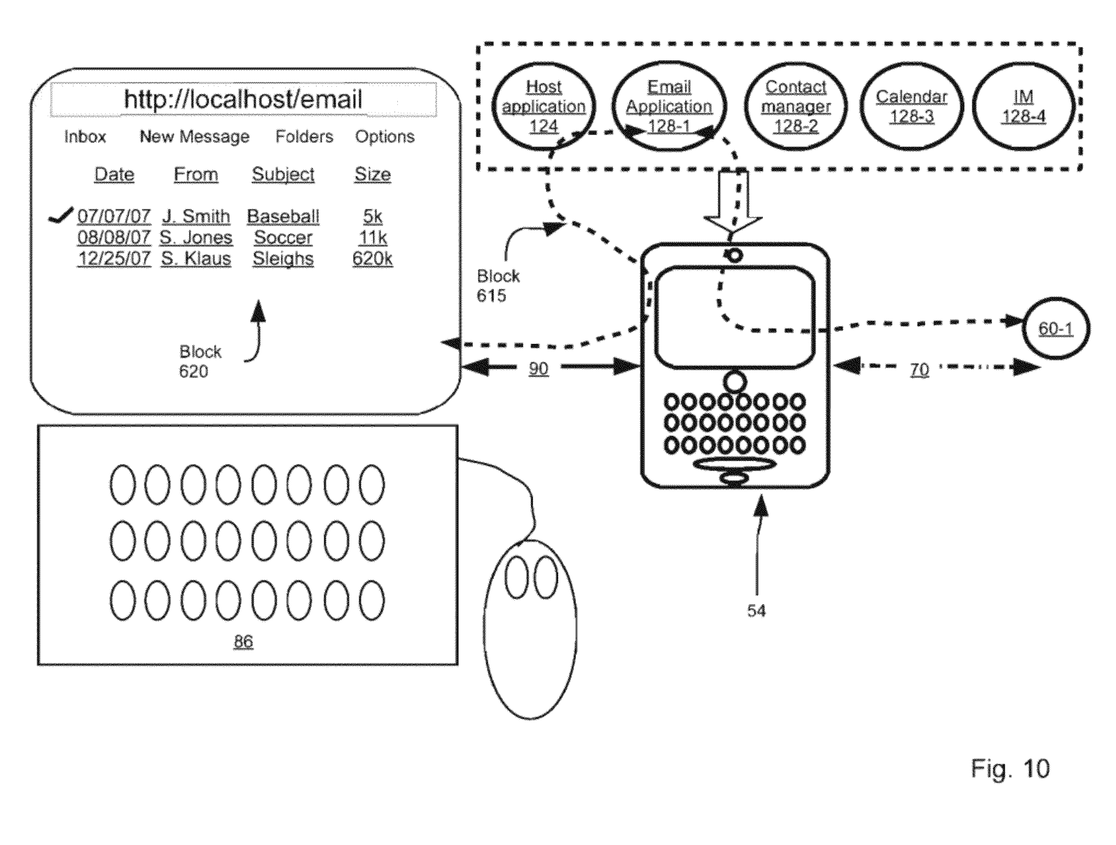

A “no” determination leads to a return to block 615 where any updates to the web page are loaded. Thereafter, method 600 continues performance as previously described. To give further explanation, and continuing with the example above where the menu selection for email was made, then during this performance of block 615 and block 620, a web page that provides web-access to email application 128-1 will be loaded and generated. This non-limiting example is shown in FIG. 10, where browser application 86 is shown as accessing the address http://localhost/email, which is hosted by host application 124 in order to provide access to email application 128-1. When system 50 is configured using plug-ins 304, then block 615 and block 620 may likewise make appropriate use of plug-in 304-1 from FIG. 5 in order to generate the display shown in FIG. 10.

When the display shown in FIG. 10 is active, then block 525 can comprise receiving any input that is relevant to email application 128-1. For example, such input may comprise selecting “New Message”, to thereby cause generation of a dialogue box on the display of client machine 86 which can be used to compose a new email message. In this example, a subsequent cycle through block 615 and block 620 would result in generation of such a dialogue box for composition of a new email message. Note that such generation is effected by host application 124 creating a web page with such a dialogue box, based on host application 124 interacting with email application 128-1, again making use of plug-in 304-1 from FIG. 5 when such a plug-in is employed. In variations, code to generate and display such a dialogue box may have been included in or referenced by the original web page, so a new web page may not need to be loaded in order for such a dialogue box to appear on the display.

In general, those skilled in the art will now appreciate that the data generated on the display of client machine 86 is under the control of device 54 and that client machine 86 is effectively a web-client while device 54 acts as a web-server. Furthermore, device 54 also uses link 70 to access the appropriate server 58 and application 60, as part of determining what data to display on the display of client machine 86. Again, in the example of email, email application 128-1 accesses application 60-1 on server 58-1 in order to send new emails generated using client machine 86 and by the same token, email application 128-1 accesses application 60-1 in order to receive new emails, which are in turn generated on the display of client machine 86. Any other functions normally associated with email application 128-1 are likewise reflected on the display of client machine 86 and appropriate access to server 58-1 is effected accordingly. In addition to static web pages, browser 88 may be configured to receive code (e.g. JavaScript code) from host application 124. While executing this code, browser 88 may, from time to time, (e.g possibly in response to user input or some other condition), request additional resources from host application 124 in order to update the page currently on the display without loading an entirely new page.

In order to configure browser 88 to respond to changes that occur on device 54, or on server 60, an “open-get” or equivalent programming function is employed so that browser 88 will automatically receive and respond to such changes. For example, assume that a new email message arrives on server 58-1, and that same new email message automatically arrives on device 54. The “open-get” function running on browser 88 will result in browser 88 also ascertaining the arrival of the new email message and result in the display of client machine 86 being updated accordingly to reflect the arrival of the new email message.

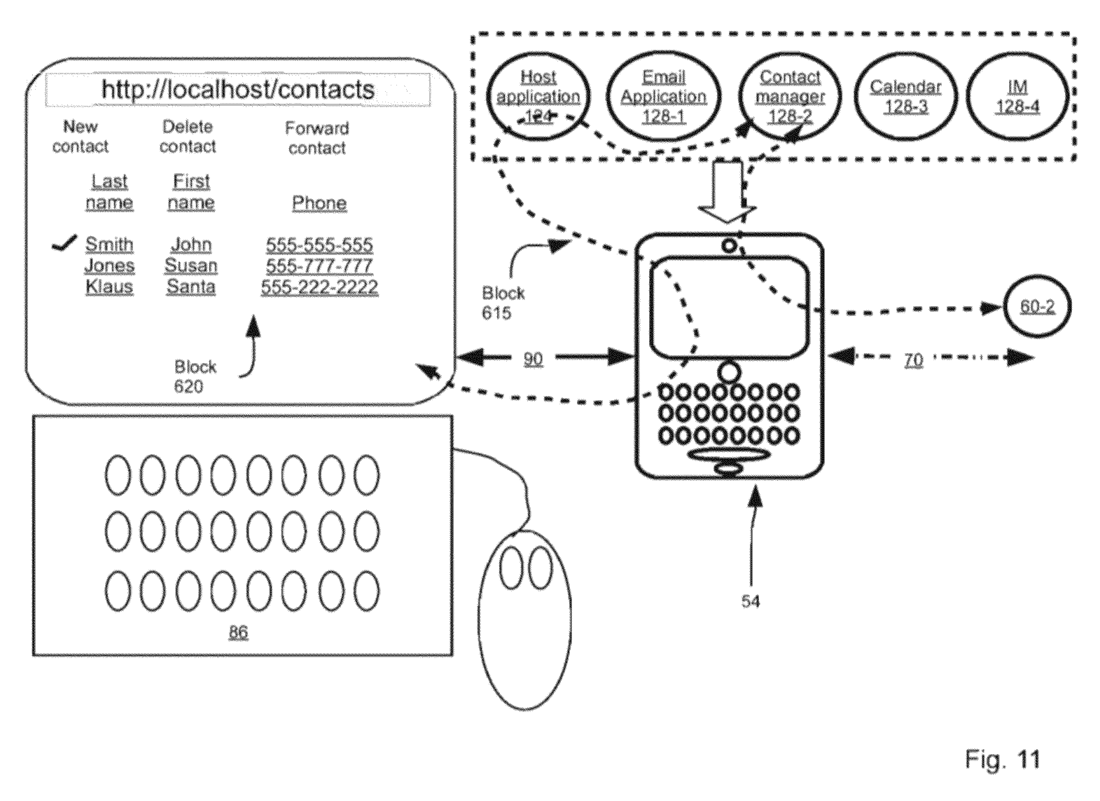

To help further illustrate the present specification, FIG. 11 shows a non-limiting example of the result of selecting contact manager application 128-2. In FIG. 11, the URL http://localhost/contacts is active and accordingly the web service 300 of host application 124 is accessing contact manager 128-2 so that input relative to contact manager application 128-2 can be received via client machine 86, and likewise, the display of client machine 86 can be controlled to display content relative to contact manager application 124. Again, changes to the contact database can be made on client machine 86, or they can be made on device 54. Such changes can then be propagated to server 60-2 in the usual manner.

Those skilled in the art will now recognize how the foregoing can extend to calendar application 128-3, instant messenger application 128-4 and other applications 128-n.

Various advantages will now be apparent. For example, it is common that communications between device 54 and servers 58 may be effected via encrypted links. Accordingly, when link 90 is active, a full browsing experience, complete with full size display and full size keyboard, can be used to interact with various applications on device 54 but such interactions will be encrypted and secure. Furthermore, in certain situations link 94 may not be available, or of limited use, due to security restrictions, usage fees, or of low bandwidth and accordingly accessing data on servers 58 from client machine 96 via link 94 may not be possible or may be impractical. Nonetheless, it may be desired to use client machine 86 for such interactions, rather than device 54, due to the availability of the full keyboard, mouse, and regular display that is available on client machine 86. Accordingly, the present specification may be most useful when device 54 is near enough to a given client machine 86 in order to establish link 90. Such client machines 86 are ubiquitous in air port lounges, hotel rooms, Internet cafes and other locations. Accordingly, for at least these reasons, this specification can be used to provide access to various applications from such client machines 86 in a novel, inventive and useful manner. It should also be noted that client machine 86 may have different configurations, and could include, for example, a tablet computer.

Variations, subsets, enhancements, and combinations of the foregoing are contemplated. For example, none of the screen shots shown in FIG. 9, FIG. 10, or FIG. 11 should be construed as being limiting as to exactly how data is generated on the display of client machine 86.

Furthermore, in relation to proxy application 308 in FIG. 7, it may be unlikely that publicly available client machines 86 will have proxy application 308 pre-installed, so as noted proxy application 308 may be stored in non-volatile storage 104 on client device 54. Further, it should be noted that non-volatile storage 104, itself, can be implemented as a removable storage media such as an SD card. Using a USB connection that proxy application 308 may be downloaded from the SD card to the client machine 86. Device 54 may also be configured so that it includes an auto-executable file which immediately executes on client machine 86 upon connection to client machine 86, and automatically copies proxy application 308 to the client machine 86. (Alternatively, device 54 can be configured so this installation is performed manually). After proxy application 308 has started, link 90 may be implemented via the USB connection or Bluetooth pairing or by other means. In the case of Bluetooth pairing, the pairing step with client machine 86 could happen in a number of ways. For example, a scan for Bluetooth devices may be initiated from either device 54 or client machine 86 or both in the usual way. Alternatively, as part of proxy application 308, the client machine 86 may be configured to display a barcode that can be scanned using optical capture unit 176. The barcode data may comprise configuration information usable by device 54 to establish pairing with client machine 86.

When a “yes” decision is reached at block 630, client machine 86 may be configured to clear its browser cache to ensure that private data has been cleared from the client machine's 86 memory. The “yes” determination at block 630 may be reached a number of ways: device 54 may be manually logged off from client machine 86; link 90 may be terminated by unplugging a USB cable used to establish link 90; link 90 may be wireless connection (e.g. Bluetooth) that has been closed. An inactivity timer may be used to reach the “yes” determination at bock 630.

Alternatively, client machine 86 may operate in a no-cache mode when connected to device 54. In this mode, performance may be somewhat degraded since browser 86 may download content more often.

As noted above, device 54 runs a host application 124 that may be configured to listen to a real time communication channel, such an instant messaging conversation via instant message application 128-4. JavaScript may be executing on browser 88, such JavaScript having been provided by host application 124. This JavaScript maintains an open connection with the host application 124. When an event occurs in application 128-4, it is returned to the JavaScript so that corresponding changes occur on the display of client machine 86 under the control over browser 88. If an instant message reply is sent from the browser 88, then a separate parallel connection is opened and the commands are sent to host application 124 which then injects them into the ongoing conversation within instant message application 128-4.

In general, it can be noted that there are many applications 128 (with corresponding data sources and networking applications 60) on devices like device 54, including without limitation email, contacts, calendar, etc. Using this specification, each application 60 and its data may be rendered using browser 88 in a customized manner. Also, newly-installed and newly-created applications 128 may be readily added as available through browser 88 by creating a new application plug-in 304 for each new application 128. Host application 124 is configured to allow for ongoing registrations of new plug-ins 304. In effect, device 54 provides an application programming interface (API) associated with host application 124 that allows any application 128 running on the device 54 to register as a data source. Each application 128 can be assigned its own URL prefix and a handler class that implements a particular interface. All hypertext transfer protocol (HTTP) requests from client machine 86 for URLs with that prefix may be given to the handler class to be processed. The HTTP handler may respond to each request in any way that it sees fit, so it is in control of the data rendering. Because registration of applications 128 with host application may be dynamic, it is not needed to compile host application 124 to be limited to only those applications 128 installed at the same time as host application 124 is installed. Newly-installed applications can register at which point they will dynamically appear as being available through browser 88. Host application 124 can also dynamically enumerate all of the registered applications 128 at the time of creating a menu screen such as the menu screen shown in FIG. 9.

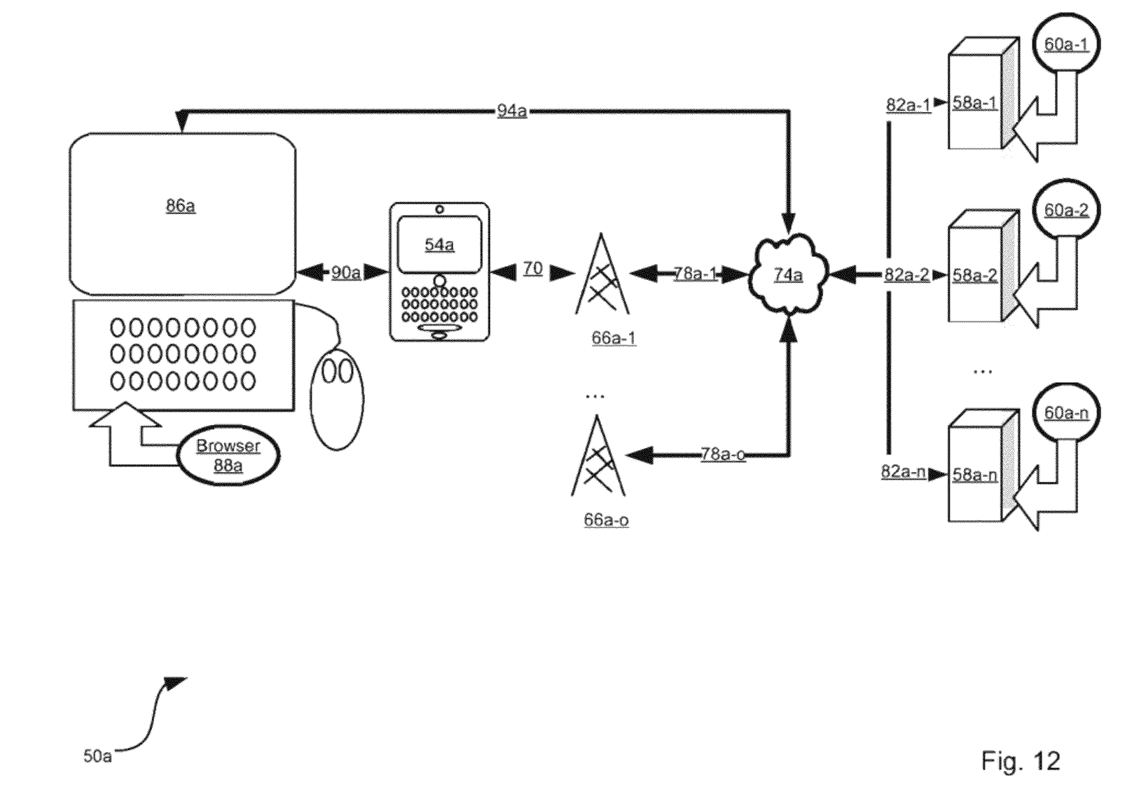

Referring now to FIG. 12 a system for providing event notifications across a plurality of computers is indicated generally at 50a. System 50a is a variation on system 50 and thus like elements bear like references to their counterparts in system 50, except followed by the suffix “a”. System 50a can be built on system 50 and its variants, and thus the particular variations of system 50a will become clearer in the following discussion.

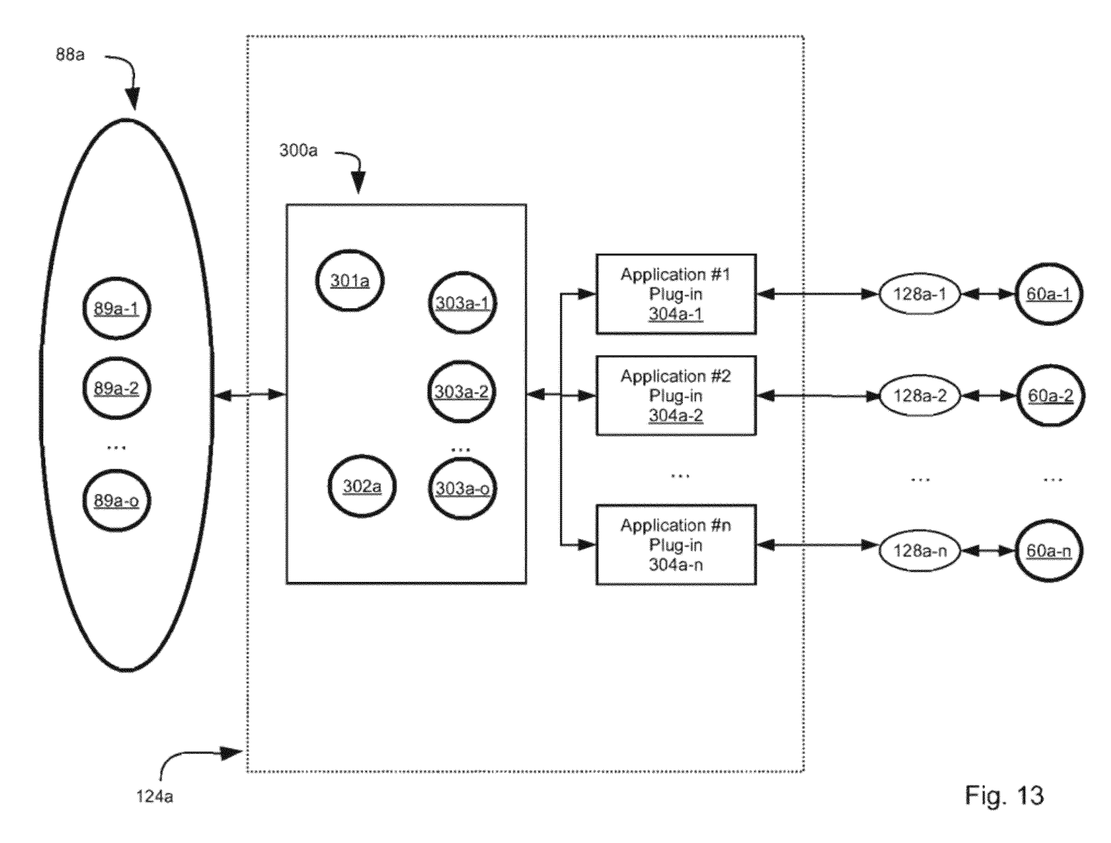

Such variations become clearer in FIG. 13. FIG. 13, which is a variation on FIG. 5, shows a block diagram of an example an implementation of host application 124a and its virtual connections to browser 88a and applications 128a. It can be noted that, according to the variation in FIG. 13, host application 124a may be modified to permanently integrate application plug-ins 304a or applications 128a, or all of them, within host application 124a, thereby foregoing the modularity of plug-ins 304a.

In FIG. 13, browser 88a is shown as including one or more asynchronous request modules 89a, and web service 300a is shown as including an asynchronous response module 301a and a queue manager 302a. It is to be understood by those skilled in the art that the term “module” need not be construed in a limiting sense, and can comprise various software structures (e.g. objects, libraries, classes, applets, functions, combinations thereof, etc.) that may be incorporated directly into, or connected to, other software components discussed herein.

FIG. 13 also shows three queues 303a within web service 300a. Note that each queue 303a may simply be a pointer to a memory location in storage unit 104 or storage unit 108 which contains the relevant data. Also note that there is no requirement that queues 303a (or indeed any other module 301a, 302a) be actually maintained within web service 300a.

These components may be architected and organized differently within device 54a.

As will be discussed further below, a queue 303a is provided respective to each request module 89a, and the existence of queue 303a assumes that a given queue 303a has been created and is active.

Asynchronous request module(s) 89a may be implemented using one or more web development techniques, such as those groups of techniques generally referred to Asynchronous JavaScript and eXtensible Markup Language (XML) (AJAX). Making asynchronous requests via asynchronous request module 89a allows browser 88a to continue running while browser 88a is waiting for responses to arrive. For example, assume that the page corresponding to http://localhost/email as shown in FIG. 10 is being generated on client machine 86. Asynchronous request module(s) 89a may execute while the display of client machine 86 shown in FIG. 10 is being generated, without interrupting the appearance of the display on client machine 86. An example of asynchronous request that could be handled by asynchronous request module 89a would involve requesting whether any new email has arrived that should be generated on the display of client machine 86. Responses to such requests would result in an indication of a new email appearing on the inbox shown on the display of client machines 86 shown in FIG. 10, thereby giving the effect of email being pushed to the client machine 86.

As another example, assume that the page corresponding to http://localhost/contacts as shown in FIG. 11 is being generated on client machine 86. Asynchronous request module(s) 89a may execute while the display of client machine 86 shown in FIG. 11 is being generated, without interrupting the appearance of display on client machine 86. An example of an asynchronous request that could be handled by asynchronous request module 89a would involve requesting whether any changes to the contact database have occurred that should be generated on the display of client machine 86. Responses to such requests would result in such changes to the contact database as shown on the display of client machines 86 shown in FIG. 11, thereby giving the appearance of such database changes being pushed to the client machine 86.

Other examples of uses of asynchronous request modules 89a are apparent to those skilled in the art, and indeed will be discussed further below.

It can also be noted that multiple web browsers, or multiple tabs within a web browser, may be open on client machine 86. For example, multiple instances of web browser 86a, or multiple tabs within web browser 86a may be open to http://localhost/email. In this circumstance, multiple asynchronous request modules 89a can be active for each instance of the web page corresponding to http://localhost/email. As will be discussed further below, asynchronous response module 301a and queue manager 302a are configured so that each instance is updated for new events so that the display of each instance remains substantially identical, but without sending duplicate copies of a response to a given instance.

In order to coordinate requests between a request module 89a and a response module 301a, each request module 89a is configured to generate a unique identifier that is used in communications with the response module 301a. One way of generating such a unique identifier is to configure request module 89a to select a random integer from a large range, which will result in a unique identifier with high probability, which thereby avoids any complex request module 89a registration protocol, although if desired such a complex registration protocol, or other different protocol, may be employed.

Response module 301a is configured so that when it receives a request from request module 89a, response module 301a will determine whether a queue exists related to the provided unique identifier. If no queue exists, then response module 301a creates a queue 303a related to that unique identifier associated with the originating request module 89a. Response module 301a is configured to then check whether there are any events present in the related queue. If so, in one implementation, response module 301a is configured to remove the first event from the queue 303a and returns the data for that event to the originating request module 89a. If the queue 303a is empty, then the response module 301a holds the request open, waiting for an event to arrive in the related queue. When an event arrives, the response module 301a removes the event from the queue 303a and returns the data for that event to the client.

Each application 128a that is executing may be configured to generate events which are returned to a request module 89a respective to a given application 128a. When an application 128a generates an event it is placed in an appropriate queue 303a.

Queue manager 302a, which is configured to work in conjunction with response module 301a, is configured to determine whether each particular queue 303a is active, and if not active, then queue manager 302a will delete the queue 303a. The queue 303a may be determined to be active if, for example, one of the following conditions is met: a request module 89a is currently waiting for an event to arrive in a given queue 303a; or the elapsed time since an event was returned from that queue 303a to request module 89a is below a particular threshold. This second condition is provided so as to account for the fact that a request module 89a may not currently be waiting for an event if the last event that was returned to the request module 89a is still undergoing processing at client machine 86a. Thus the threshold is set to a value that reflects the amount of time expected to process an event by browser 88a. However, each request module 89a that wishes to continue receiving events is expected to make a subsequent request to device 54a within a relatively short period of time to issue a request for the next event.

In general, response module 301a or queue manager 302a, as desired, is configured to place events into appropriate active queues 303a, while queue manager 302a is configured to remove every inactive queue 303a from its list of queues 303a. Queued events are returned to request modules 89a as described above.

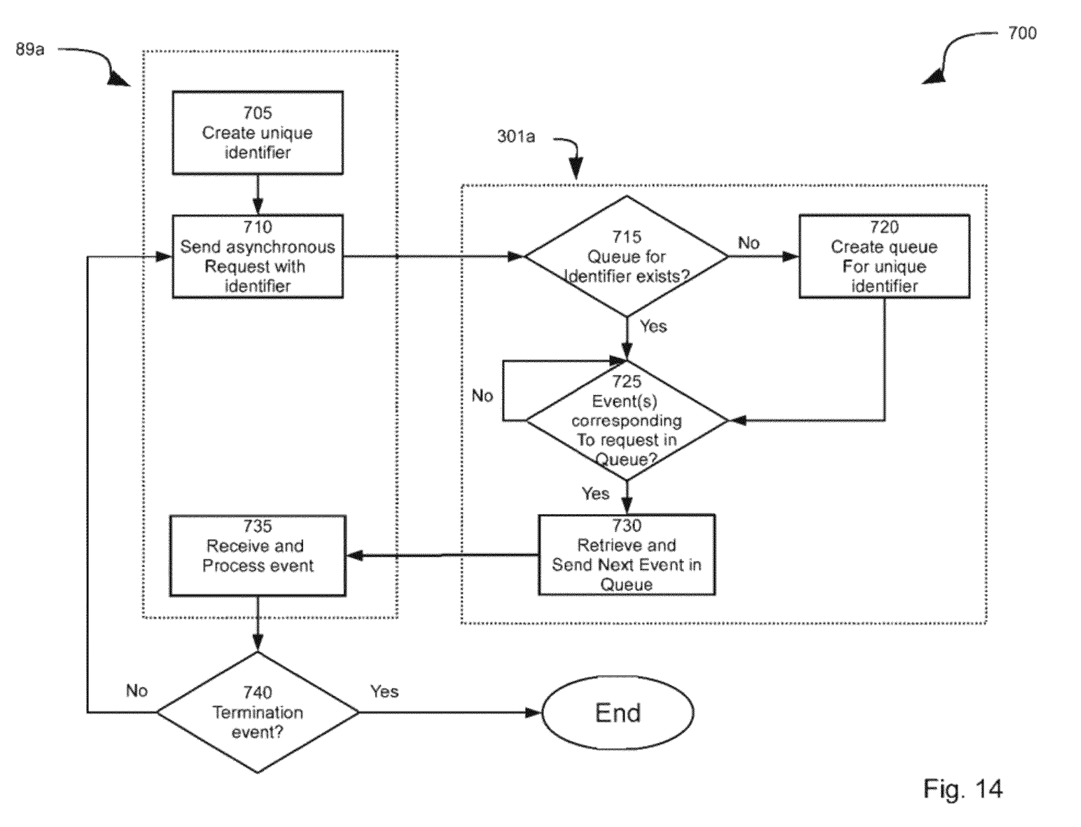

Referring now to FIG. 14, a method of providing event notifications across a plurality of computers is depicted in the form of a flow chart that is indicated generally at 700. Method 700 can be implemented on system 50a, or a variant thereon. However, method 700 is described for illustrative purposes in relation to system 50a, and thus those blocks of method 700 that are performed by request module 89a are denoted by a stippled-line box encircling those blocks. By the same token, those blocks of method 700 that are performed by response module 301a are denoted by a stippled-line box encircling those blocks.

Method 700 can be performed as a part of performance of block 620 of method 600.

Block 705 comprises creating a unique identifier. In a present example, block 705a is performed by a request module 89a that is respective to a given web page that is open on a client machine 86a that is also respective to a given application 128a, in accordance with the previous discussion in relation to system 50. As noted above, one way of generating a unique identifier is to select a random integer from a large range, which will result in a unique identifier with high probability.

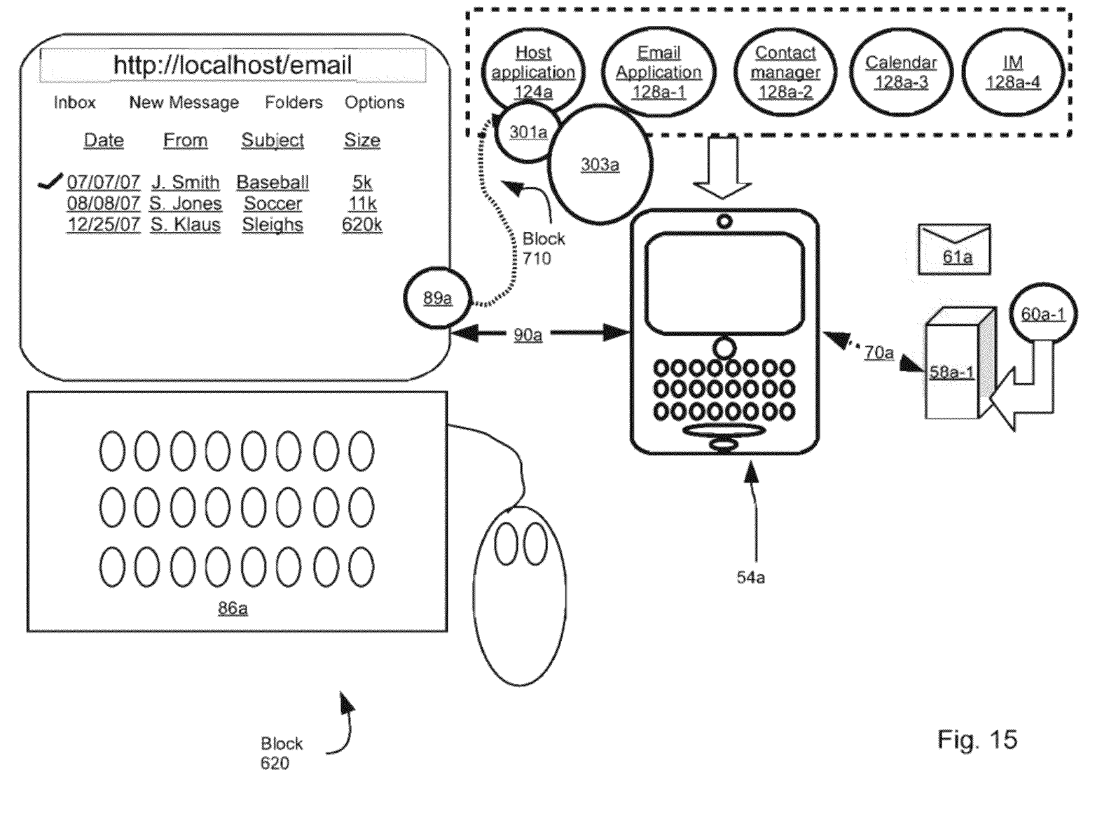

Block 710 comprises sending an asynchronous request with the identifier from block 705. Again, the nature of the request is not particularly limited, and can generally correspond to any aspect of a particular application 128a where events within that application 128a are ultimately relevant to the web page on client machine 86a that initiates method 700. To help illustrate, however, FIG. 15 shows the generation of a web page on the display of client machine 86a that corresponds to email application 128a-1, having the URL http://localhost/email. The request at block 710, in this example, is a check for whether any new email messages have been received in device 54 that should be made available on client machine 86a. Thus, the asynchronous request in FIG. 15 is labeled at block 710.

When the request is received at device 54a, then block 715 commences. Block 715 comprises determining if an event queue 303a for the identifier associated with the request at block 710 exists. If no queue 303a exists, then at block 720, then such a queue 303a is created so that future events which are received at device 54a for the relevant application 128a can be stored in that queue. In the example in relation to FIG. 15, the future events comprise the receipt of new email messages.

Block 725 comprises determining if any events corresponding to the queue 303a associated with the identifier from block 705 exists. A “no” determination results in a “wait” state where block 725 continues to be invoked until an event is received. While not shown in FIG. 14 for ease of illustration, it is to be understood that interrupt modules are typically employed so that on a termination event occurring during the loop at block 725 will result in termination of the loop. Termination events are discussed below in relation to block 740, but may comprise, by way of non-limiting example, any breakage of link 70a, or a closure of the web page that resulted in the original generation of the request at block 710. Other types of termination events will occur to those skilled in the art.

A “yes” determination at block 725 leads to block 730. A “yes” determination is reached when one or more events are found within the queue 303a contemplated at block 725.

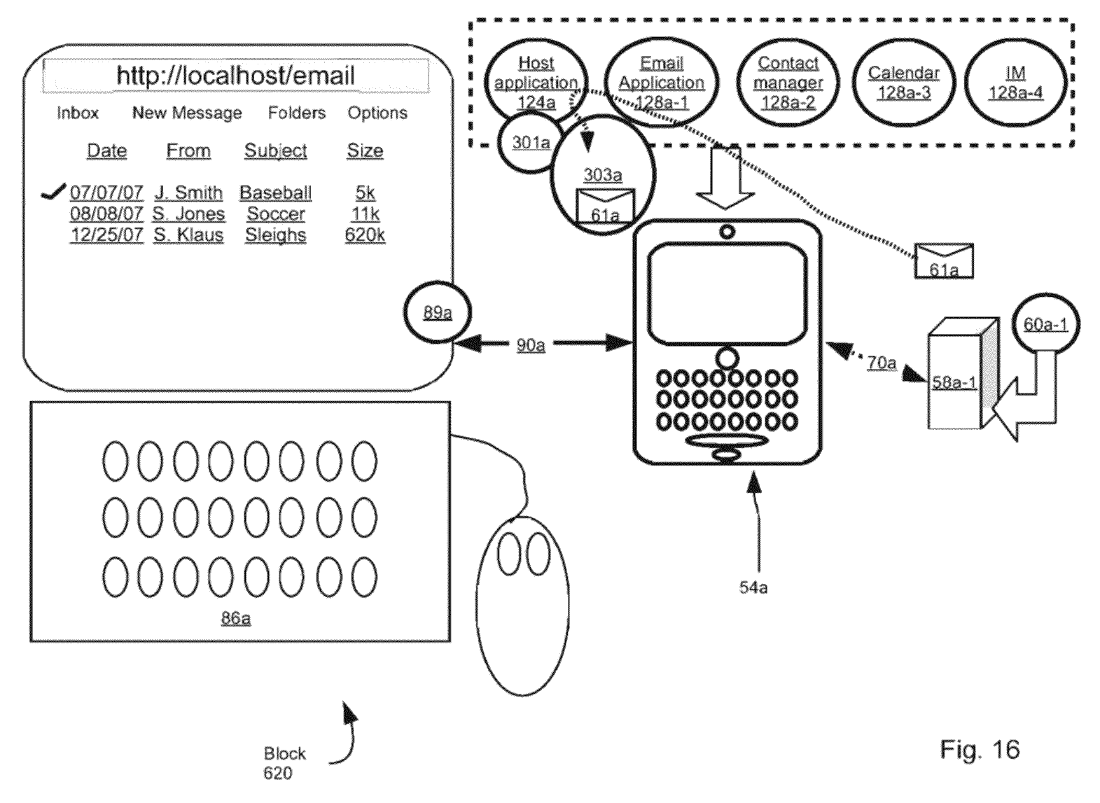

The means by which the queue 303a is populated with an event is not particularly limited. However, an illustrative example of populating a queue 303a in relation to email application 128a-1 is represented in FIG. 15 and FIG. 16. In this case, the event is the arrival of a new email, and the data associated with the event is the email itself. In FIG. 15, an email 61a is shown located at server 58a-1 in conjunction with application 60a-1. However since that email has not been delivered to device 54a, the queue 303a contemplated in FIG. 15 remains empty. In FIG. 16, email 61a is shown as having been received by email application 128a-1, and is therefore, via application plug-in 304a-1 placed within queue 303a that is accessible by response module 301a.

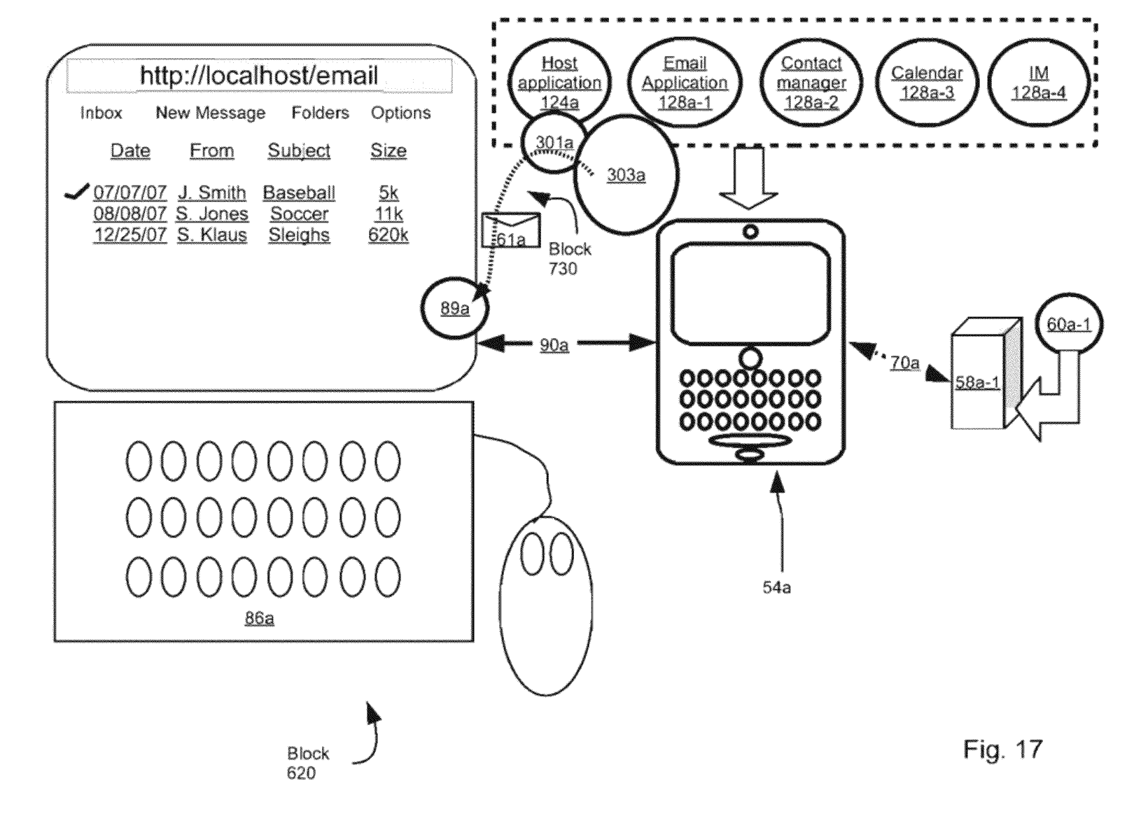

Block 730 comprises retrieving and sending the next event in the queue. In a present implementation, it is contemplated that where the queue 303a has multiple events stored therein, only the first item in the queue 303a would be retrieved and sent, leaving the remaining items in the queue 303a for subsequent cycling through method 700. Example performance of block 730 is shown in FIG. 17, where email 61a is sent from device 54a to client machine 86a. Since, in the present illustrative example, only one item was in queue 303a, then as a result of block 730, queue 303a is shown as empty in FIG. 17 while email 61a is delivered to request module 89a.

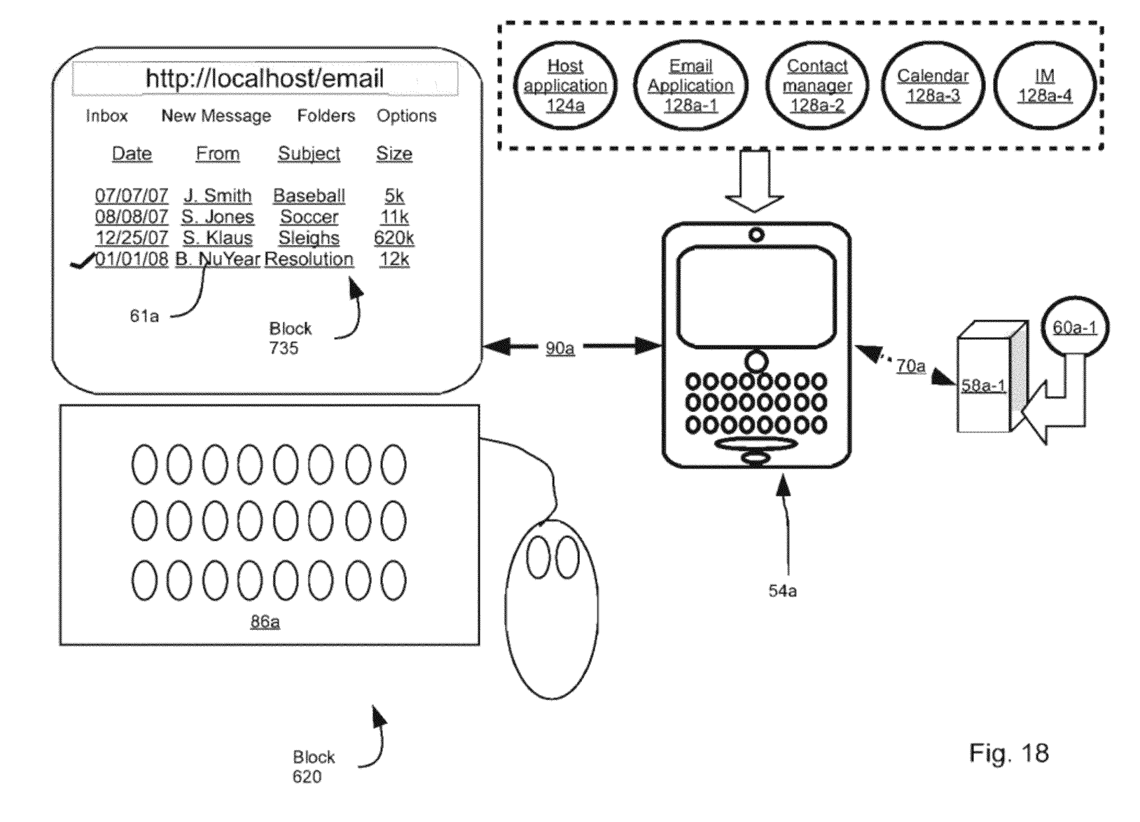

Block 735 comprises receiving and processing the event. Block 735 thus responds to the event sent at block 730, and upon its receipt, is processed locally at the receiving client machine 86a according to the programming instructions associated with the web page associated with request module 89a. Example performance of block 735 is shown in FIG. 18, where email 61a is shown as a newly received email within the “inbox” on the display of client machine 86a, as a new email with the date “Jan. 1, 2008”, and from “B. NuYear”, with the subject “Resolution” and having a size of “12 k”.

Block 740 comprises determining if a termination event has occurred, in which case method 700 ends. Block 740 can be performed by either client machine 86a or device 54a or both of them and it is for this reason that block 740 is not illustrated in association with either. What constitutes a termination event is not particularly limited, and can comprise, by way of non-limiting example, termination of link 90a, closing of web browser 88a, powering off of device 54a or client machine 86a. Also as noted is that block 740 can be performed in parallel with any of the other blocks in method 700.

Where a termination event does not occur, then a “No” determination is made at block 740 and method 700 returns to block 710 at which point another asynchronous request is sent, which reuses the identifier generated at block 705. Assuming a queue 303a corresponding to that identifier exists, then asynchronous response module 301a will directly traverse from block 715 to block 725, bypassing block 720.

It will now be more apparent that the requests generated at block 710 can be asynchronous in relation to the populating of the corresponding queue 303a. Where the queue 303a is empty, then, assuming no other termination event occurs, the wait state at block 725 is effected until the queue 303a is populated. Conversely, if the queue 303a contains more than one entry, then each individual event in the queue 303a is sent, one at a time, once during every pass through block 730, until the queue empty. However, at the speed at which method 700 can be configured to occur, even considering for the asynchronicity, very little time need actually pass between the arrival of an event (e.g. an email message) at device 54a, and the appearance of that event (e.g. a new email in the inbox) on the display of client machine 86a. The amount of time that actually passes can, in certain configurations, be in the order of a few milliseconds.

Queue manager 302a is provided to help further manage queues 303a. As discussed above, applications 128a running on device 54a generate events which are populated into any active queues 303a. Queue manager 302a is configured to examine all of the queues 303a to determine if they are active. Queue manager 302a determines that a particular queue is “active” if one of the following conditions is met:

1) a request module 89a is currently waiting for an event to arrive in a respective queue 303a. This condition corresponds to method 700 remaining at the wait state at block 725.

2) the elapsed time since an event was returned from that queue to a client is below a particular threshold. This condition corresponds to a period of time since block 730 was commenced. Note that this second condition is provided to account for the fact that block 735 may be occurring during an interval when browser 88a is actually handling an event received at block 735. Thus, at block 735, request module 89a may not currently be waiting for an event since the browser 88a is currently processing the last event that was returned to it. In that case, however, queue manager 302a still expects a further invocation of block 710, involving a subsequent request to response module 301a, within a relatively short period of time. If this time period is exceeded, then a determination is made that the particular queue 303a is not active.

In the event that a given queue 303a is determined to be active, then queue manager 302a places the event into every active queue 303a corresponding to that application.

In the event that a given queue 303a is determined to be inactive, then queue manger 302a removes that queue from its list of queues.

Again, various circumstances may arise leading to termination of the cycles of requests and response. For example, if request module 89a is waiting for response, but the underlying data connection is lost (e.g. link 90 is terminated), then response module 301a will abandon queues created responsive to requests generated by request modules 89a.

Various advantages will now be apparent. For example, dynamic creation of queues and deletion of those queues makes efficient use of processor resources. More specifically, each request module 89a has the ability to cause the creation of a new queue 303a of events that will be returned to the unique request module 89a, and once the client has stopped making requests, the queue 303a will be removed automatically. This can obviate or mitigate the need for complicated registration protocols and accommodates connections that are dropped without any formal handshake. The determination of whether a queue 303a is active, and the fact that response module 301a can be configured to examine whether a request module 89a is waiting, reduces the likelihood of race conditions between events arriving within host application 124a and requests from request modules 89a. Taken together, these techniques allow any number of individual request modules 89a associated with different instances of web pages on client machine 86 to reliably receive pushed events one at a time, and in an orderly manner. Furthermore, the timely deletion of excess queues can save processing, memory and power resources on device 54a.

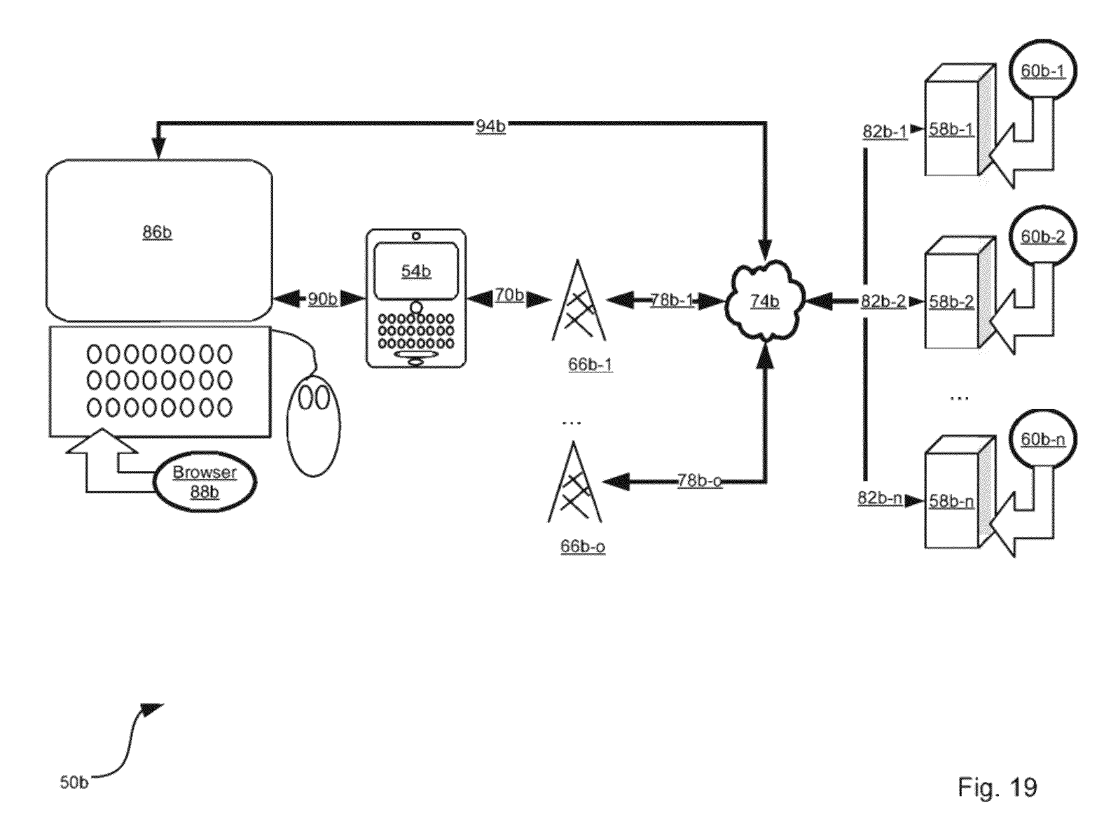

Referring now to FIG. 19 another system for providing event notifications across a plurality of computers is indicated generally at 50b. System 50b is a variation on system 50a and thus like elements bear like references to their counterparts in system 50, except followed by the suffix “b”. System 50b can be built on system 50a and its variants, and thus the particular variations of system 50b will become clearer in the following discussion.

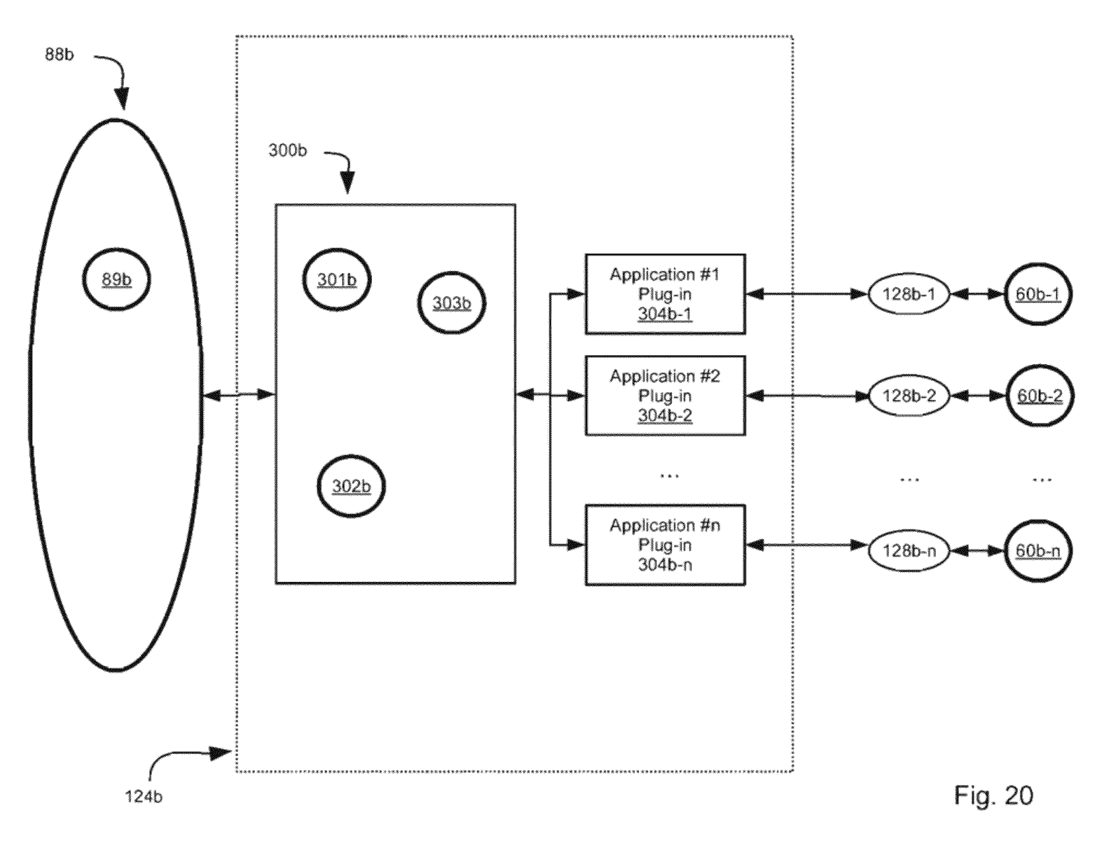

Such variations become clearer in FIG. 20. FIG. 20, which is a variation on FIG. 13, shows a block diagram of an example an implementation of host application 124b and its virtual connections to browser 88b and applications 128b. It can be noted that, according to the variation in FIG. 20, host application 124b may be modified to permanently integrate application plug-ins 304b or applications 128b, or all of them, within host application 124b, thereby foregoing the modularity of plug-ins 304b.

In FIG. 20, browser 88b is shown as including at least one asynchronous request module 89b, and web service 300b is shown as including an asynchronous response module 301b and a queue manager 302b. It is to be understood by those skilled in the art that the term “module” need not be construed in a limiting sense, and can comprise various software structures (e.g. objects, libraries, classes, applets, functions, combinations thereof, etc.) that may be incorporated directly into, or connected to, other software components discussed herein.

FIG. 20 also shows at least one queue 303b within web service 300b. Note that queue 303b may simply be a pointer to a memory location in storage unit 104 or storage unit 108 which contains the relevant data. Also note that there is no requirement that queue 303b (or indeed any other module 301b, 302b) be actually maintained within web service 300b. These components may be architected and organized differently within device 54b.

As will be discussed further below, queue 303b is provided respective to each request module 89b, and the existence of queue 303b assumes that queue 303b has been created and is active.

Asynchronous request module(s) 89b may be implemented using one or more web development techniques, such as those group of techniques generally referred to Asynchronous JavaScript and eXtensible Markup Language (XML) (AJAX), or the programming techniques generally referred to as Comet (in which a long-held HTTP request allows a web server to push data to a browser, without the browser explicitly requesting it), or combinations of AJAX and Comet. Making asynchronous requests via asynchronous request module 89b allows browser 88b to continue running while browser 88b is waiting for responses to arrive.

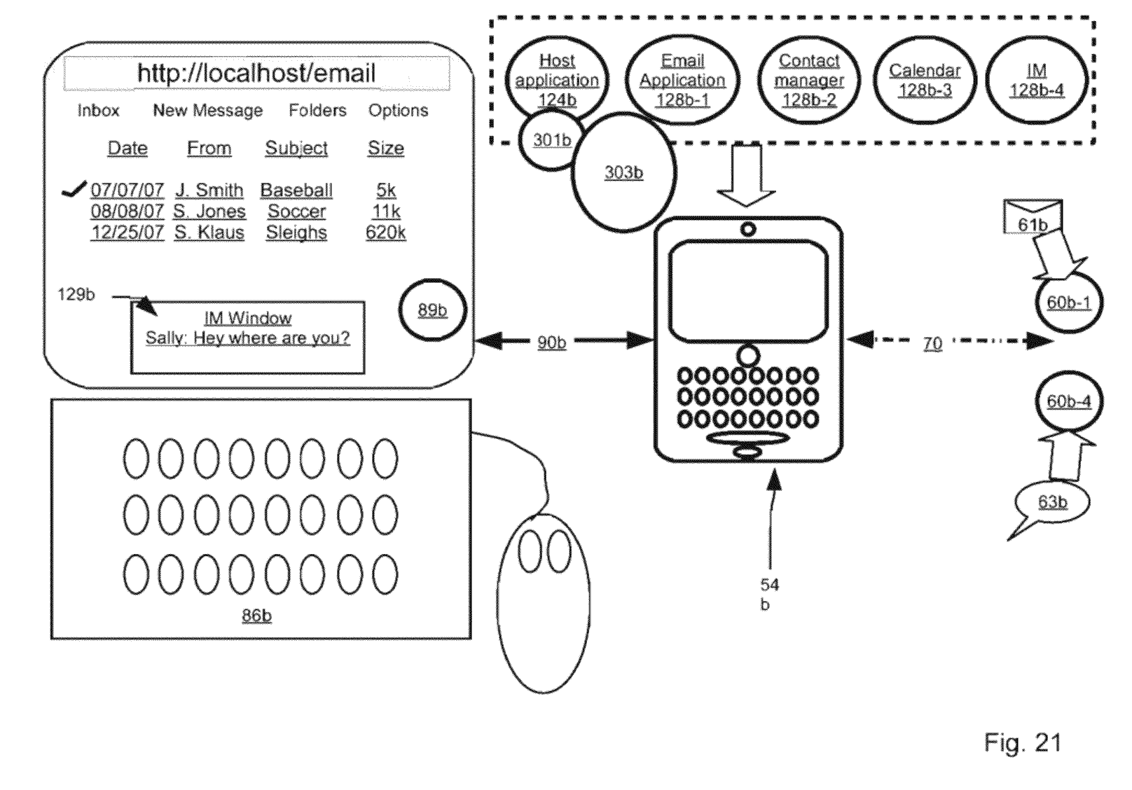

For example, assume that the page corresponding to http://localhost/email as shown in FIG. 21 is being generated on client machine 86b. The view in FIG. 21 will be recognized as a variant on the view on FIG. 10, however, the page corresponding to http://localhost/email also is shown with an instant message (IM) text window 129b that corresponds to messages generated via IM application 128b-4, but are otherwise running within the Inbox view of email application 128b-1 as generated on client machine 86b. Asynchronous request module(s) 89b may execute while the display of client machine 86b shown in FIG. 21 is being generated, without interrupting the appearance of the display on client machine 86b. An example of asynchronous requests that could be handled by asynchronous request module 89b may involve: a) requesting whether any new email has arrived at email application 128b-1 that should be generated on the display of client machine 86b and b) requesting whether any new instant messages have arrived at IM application 128b-4 that should be generated within IM text window 129b. Responses to such requests may therefore result in a) new email appearing on the inbox shown on the display of client machines 86b shown in FIG. 21 thereby giving the effect of email being pushed to client machine 86b, or b) new instant messages appearing within IM text window 129b thereby giving the effect of IM being pushed to client machine 86b.

Another example of use for asynchronous request modules 89b within http://localhost/email may comprise requests relative to contact manager application 128b-2, so that if any changes are effected to the contacts database, then those updates will be available for the autocomplete function that can be provided within the “To” box for the composition of a New email message. Other web pages may want to listen to a different set of data types, and other example for uses of asynchronous request module 89b are apparent to those skilled in the art, and will be discussed further below.

Generally, request module 89b is configured to allow a single request to specify multiple types of data that are of interest to the client. A unique identifier is created for each request module 89b, which uniquely identifies it to the response module 301b. For example, a request module 89b may be provided for the web page instance corresponding to http://localhost/email as shown in FIG. 21, that includes both an email inbox as well as an IM text window 129b. The technique discussed above in relation to block 705 may be used to generate the unique identifier. Alternatively, response module 301b, or another software module on device 54b may generate the unique identifier in response to a request from request module 89b.

In one implementation, once the unique identifier exists, a first request from request module 89b is provided to response module 301b, which includes the unique identifier and a list of the relevant data types. In the non-limiting example of FIG. 21, the relevant data types include incoming emails and incoming instant messages. This request from request module 89b may be in the form of an HTTP GET or POST request, for example. Request module 89b then makes subsequent requests providing only the unique identifier, as the relevant data types are now recorded by the response module 301b. Therefore, the subsequent requests are kept small, as a list of relevant data types need not be submitted each time.

In a variation, module 89b does not generate its unique identifier, but instead response module 301b generates a unique identifier and sends it back to the request module 89b in response to the first request.

In another implementation, each request made by the client contains the unique identifier, however generated, and a list of relevant data types. In this implementation, the response module 301b need not remember the data types that are relevant to each request module 89b between requests.

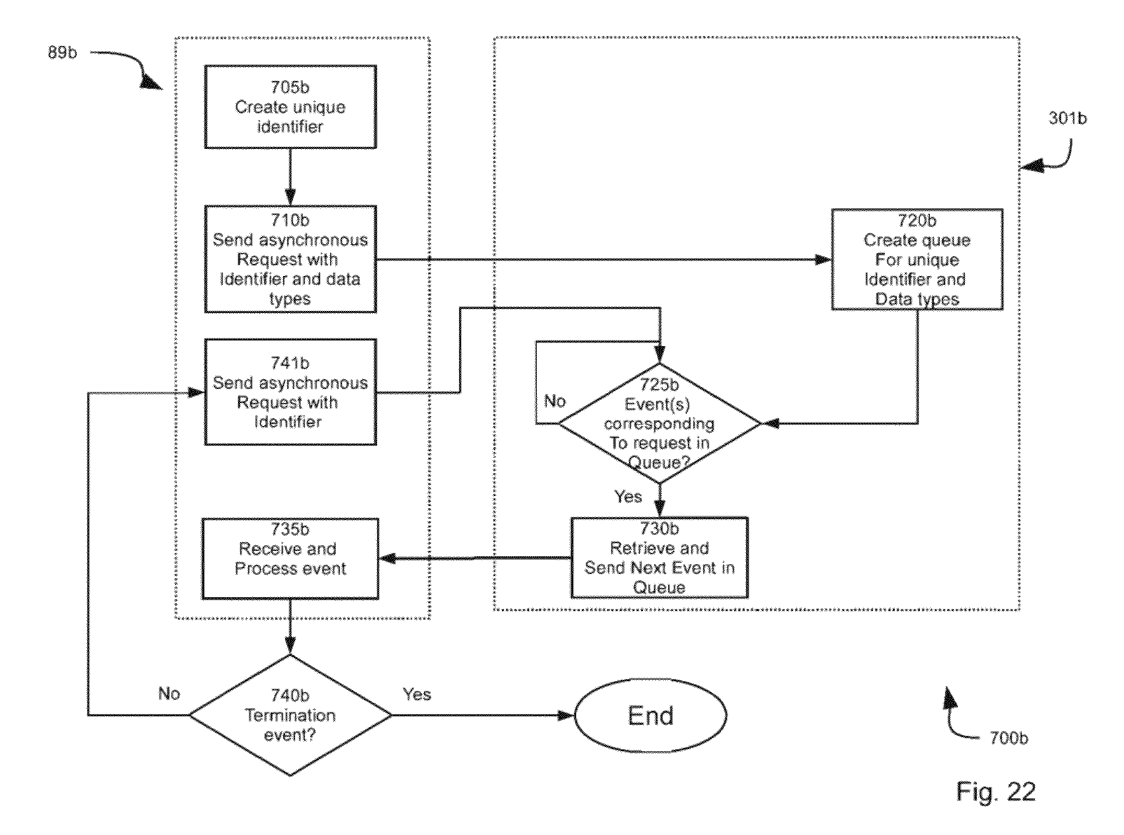

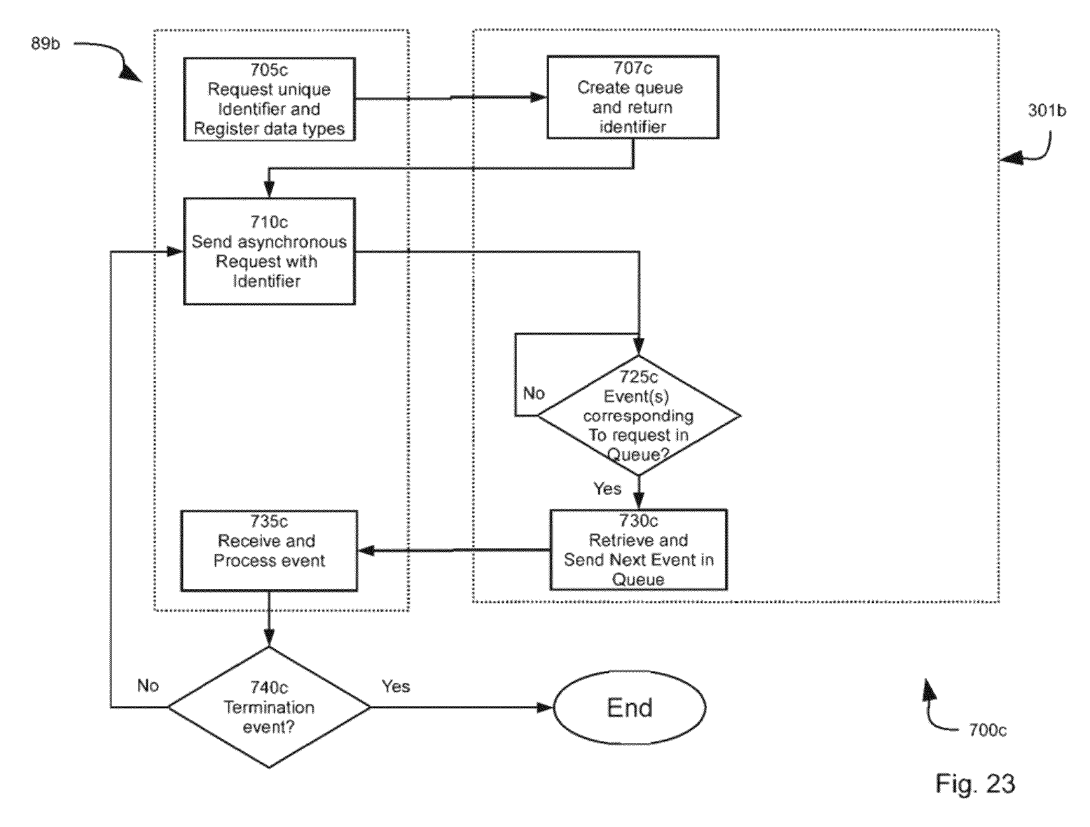

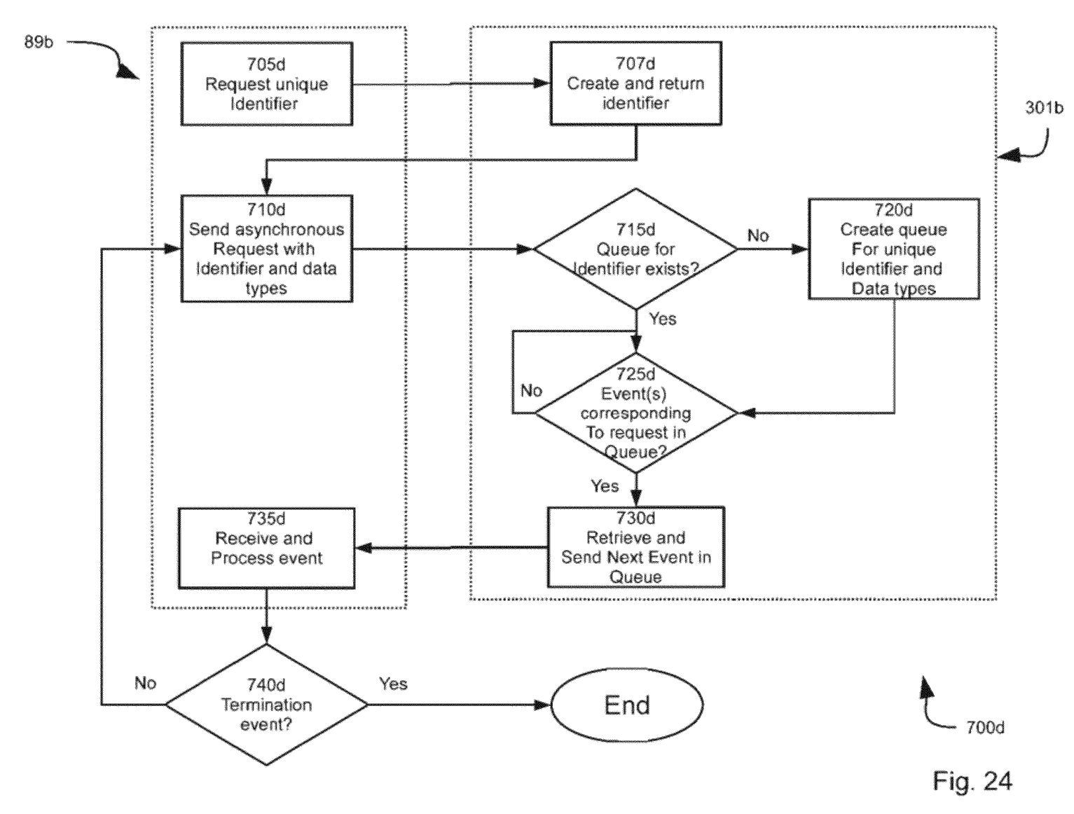

These general implementation approaches are described more fully, by way of non-limiting examples, as method 700b in FIG. 22, method 700c in FIG. 23, and method 700d in FIG. 24. Method 700b, method 700c and method 700d are variants of method 700, and like blocks have like references except followed by a unique suffix letter.

Of note is that in method 700b, at block 710b an initial asynchronous request is sent with the unique identifier, along with the data types of interest by request module 89b. In the non-limiting example of FIG. 21, the data types of interest comprise email messages associated with email application 128b-1, and instant messages associated with IM application 128b-4. Block 720b contemplates that when the queue is initially created, the various data types are registered. Such a registration is then used by host application 124b in cooperation with the relevant applications 128b to populate queue 303a with relevant events. Block 725b contemplates determining whether events of any of the corresponding data types (e.g. email messages or instant messages) are in the queue 303a. Block 730b contemplates retrieving and sending the next event in the queue back to request module 89b. Block 735b contemplates the processing of the received event (e.g. populating the email inbox with the new message, or populating the IM text box 129b with the new text message), depending on the received event type.

Of note is that in method 700c, block 705c contemplates that module 89b will initially request that response module 301b generate a unique identifier, and that at block 707c response module 301b will generate such an identifier and return that identifier back to request module 89b. At the same time, block 705c contemplates that request module 89b will send a list of the data types of interest, and block 707c contemplates that response module 301b will generate a queue that corresponds to the identifier and registers the data types of interest.

Block 710c contemplates that, once the unique identifier is created, all subsequent requests from request module 89b need only include the unique identifier, as response module 301b will inherently know which data types are of interest due to the registration event at block 707c. The remainder of method 700c is performed in substantially the same manner as the corresponding block in 700b.

Of note is that in method 700d, block 705d and block 707d contemplates only the generation of the unique identifier by response module 301b, but not the creation of the queue. Block 710d contemplates that subsequent requests will include both the unique identifier and an indication of the data types of interest. (Note that block 705d and block 707d can be replaced with block 705 of method 700, and vice versa.)

Block 715d and block 720d may be performed substantially the same way as their counterparts in method 700. As a variation, after a “yes” determination at block 715d, a check (not shown) may be performed to determine if the data types sent at block 710d are the same as the data types associated with the queue 303b created at block 720d. If there is any change in the data types then the structure of queue 303b may be modified according. For example, certain data types may be omitted from the request from block 710d which were originally included during a previous performance of block 710d. In this situation, the events in queue 303b respective to those data types may be deleted to save memory and processing resources, and an update would be made to the structure of queue 303b to omit further inclusion of the omitted data types.

Block 725d and block 730d perform substantially the same way as their counterparts in method 700b and method 700c.

Having provided certain specific examples of how various blocks from method 700, method 700b, method 700c, and method 700d can be combined and varied, other variations will be apparent to those skilled in the art.

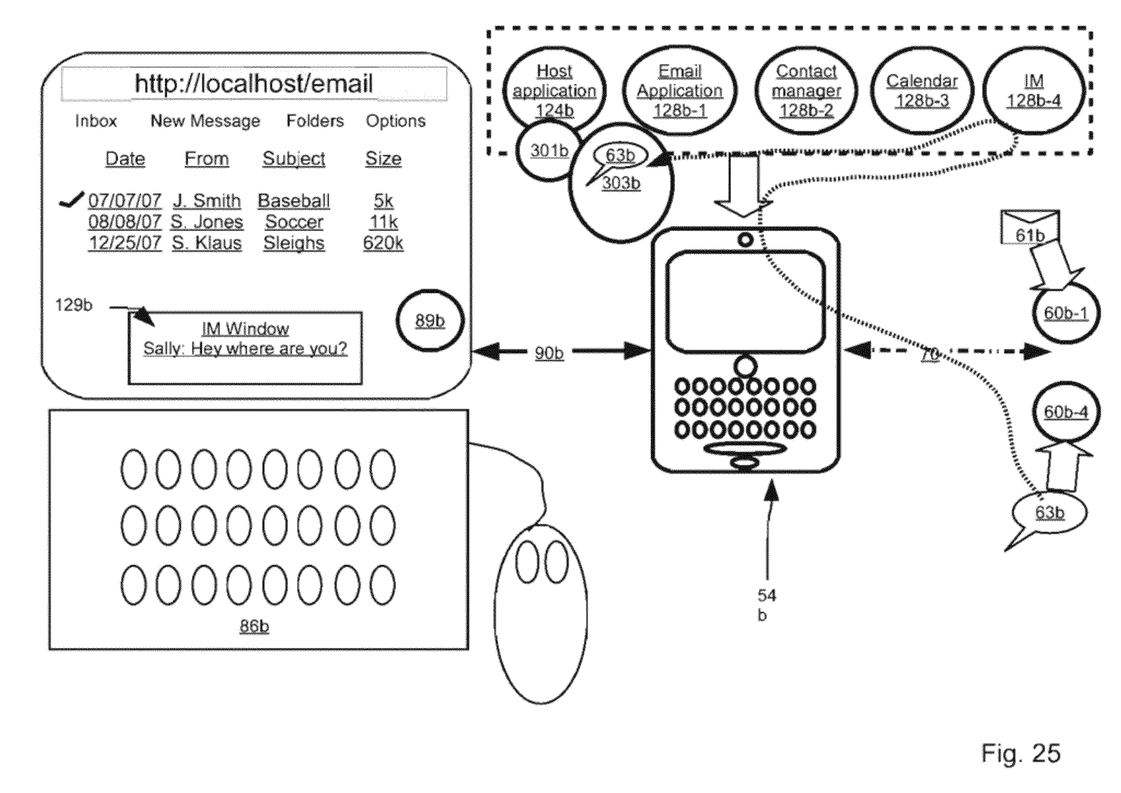

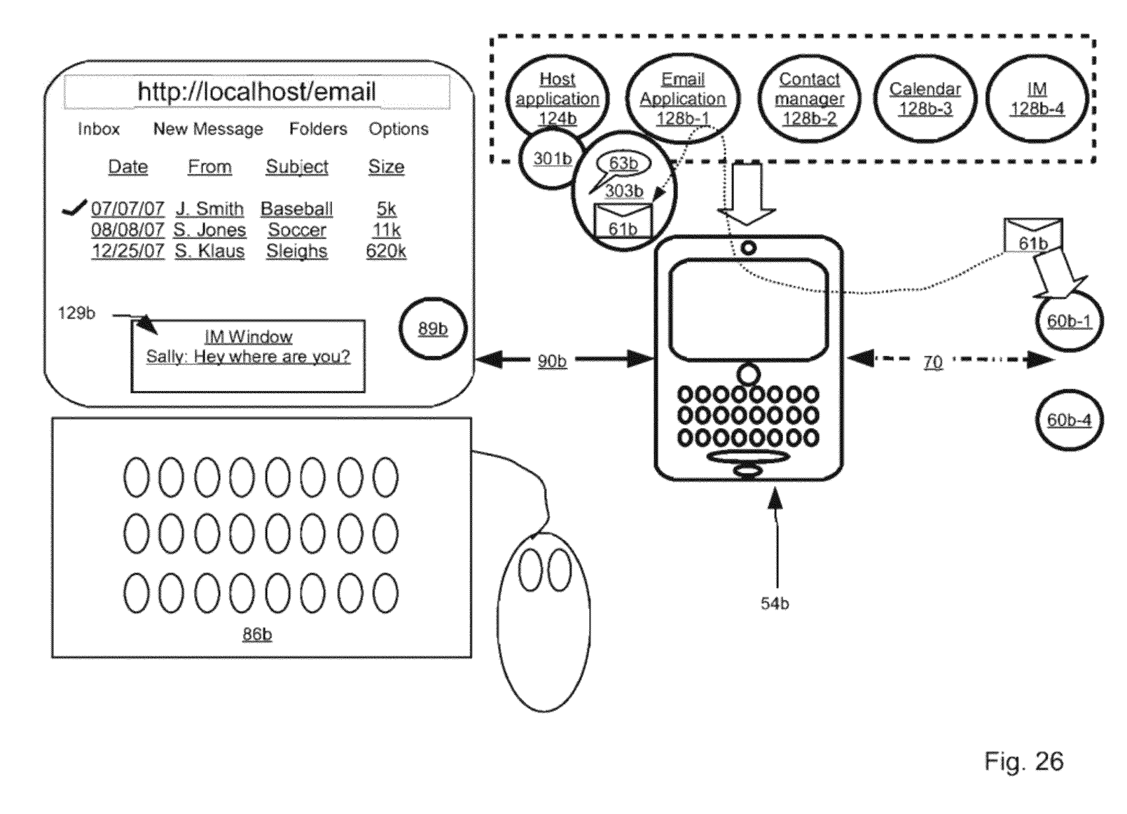

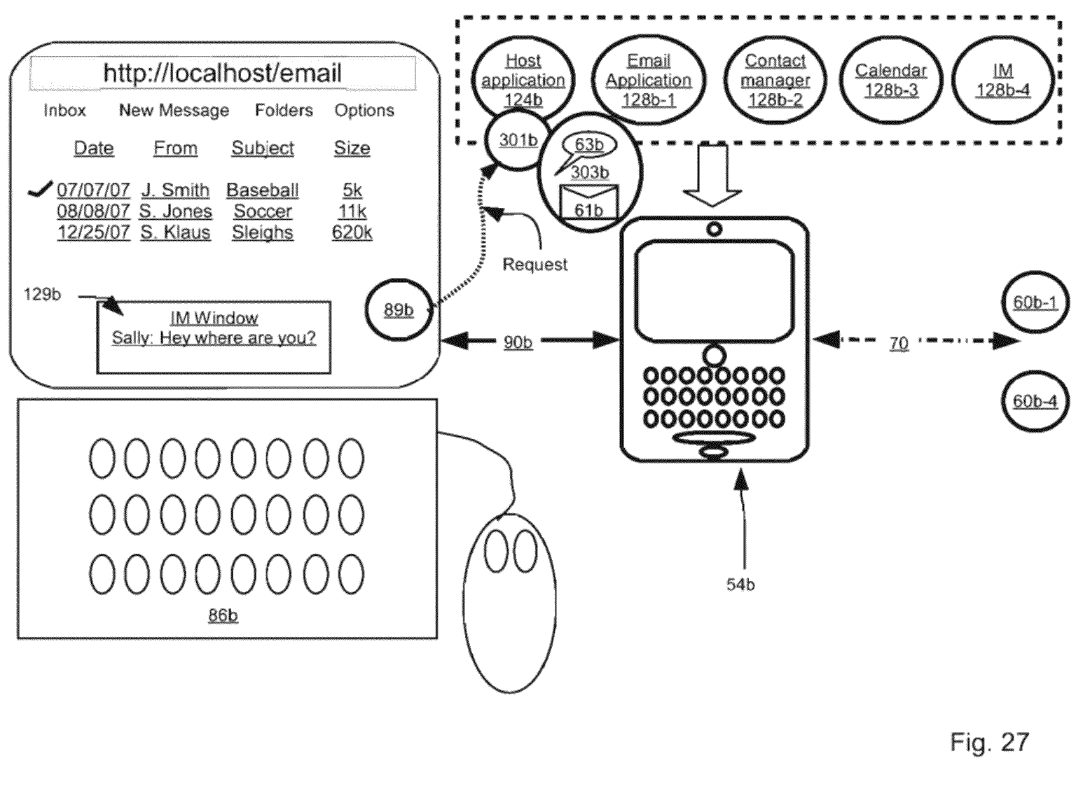

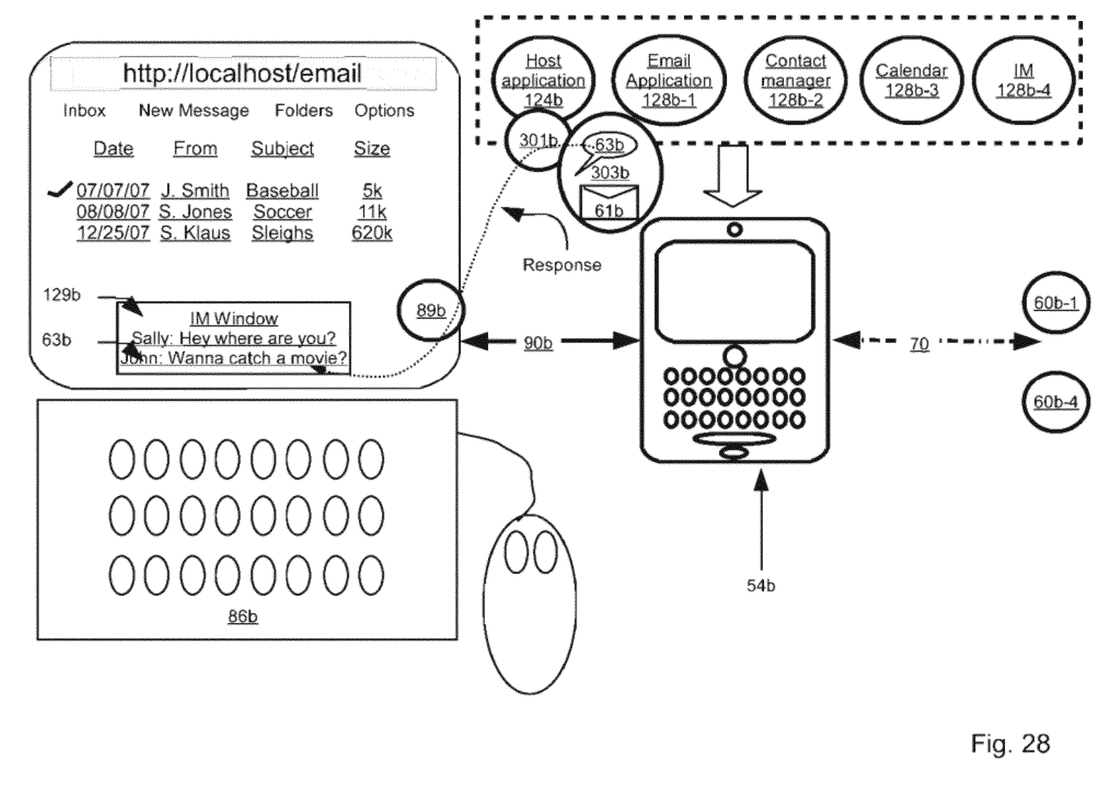

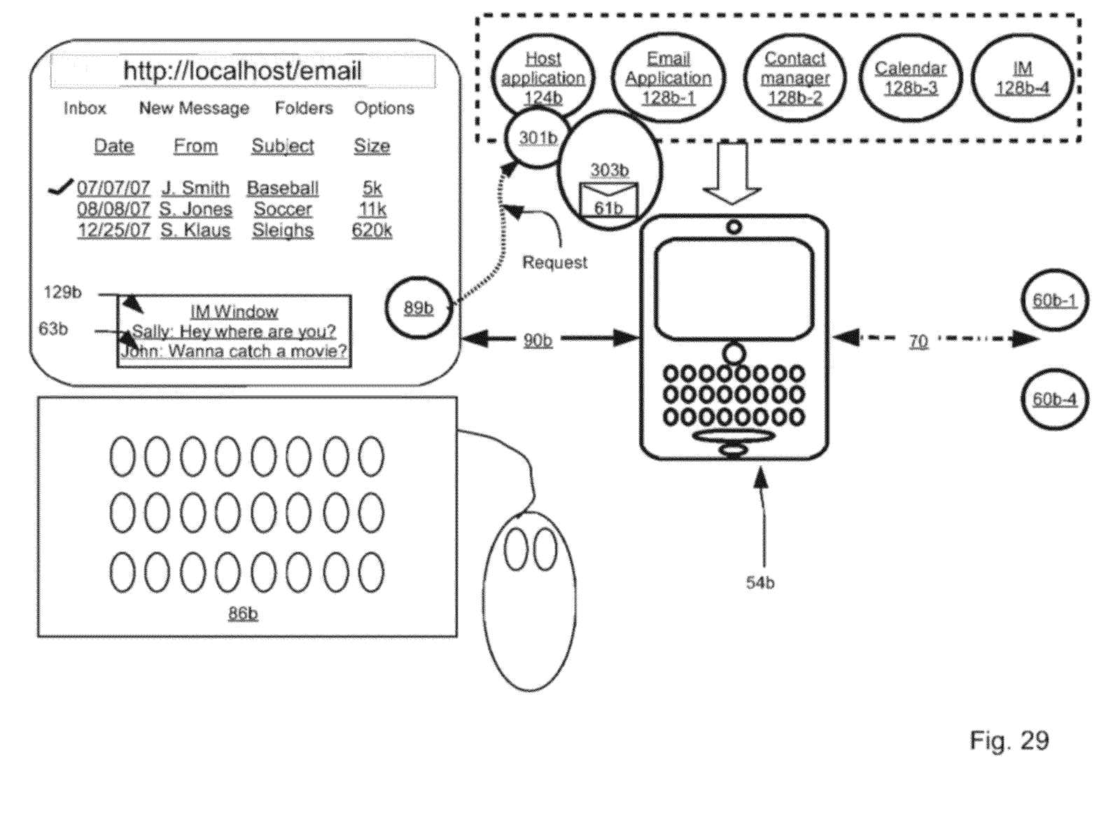

FIG. 25, FIG. 26, FIG. 27, FIG. 28 and FIG. 29 show a non-limiting example of how a new email 61b and a new instant message 63b can be delivered to client machine 86b using any one of method 700b, method 700c or method 700d, or combinations or variants thereof. The example assumes that a queue 303b has already been created for the data types of interest in accordance with any of the foregoing teachings.

FIG. 25 shows the delivery of instant message 63b to device 54b and its placement in queue 303b. FIG. 26 likewise shows the delivery of email 61b to device 54b and its placement in queue 303b.

FIG. 27 shows a request made by module 89b. The request in FIG. 27 may correspond to block 741b, block 710c or block 710d, depending on the choice of implementation.

FIG. 28 contemplates a response from module 301b in response to the request from FIG. 27. The response may correspond to block 730b, block 730c or block 730d, depending on the choice of implementation. The response comprises, in the example of FIG. 28, the delivery of instant message 63b to request module 89b. Instant message 63b is then generated within text window 129b and is shown, by way of example, as reading “John: Wanna catch a movie?”.

FIG. 29 contemplates a further request made by module 89b. The request in FIG. 29 may correspond to block 741b, block 710c or block 710d, depending on the choice of implementation, as part of a further cycling through the relevant method.

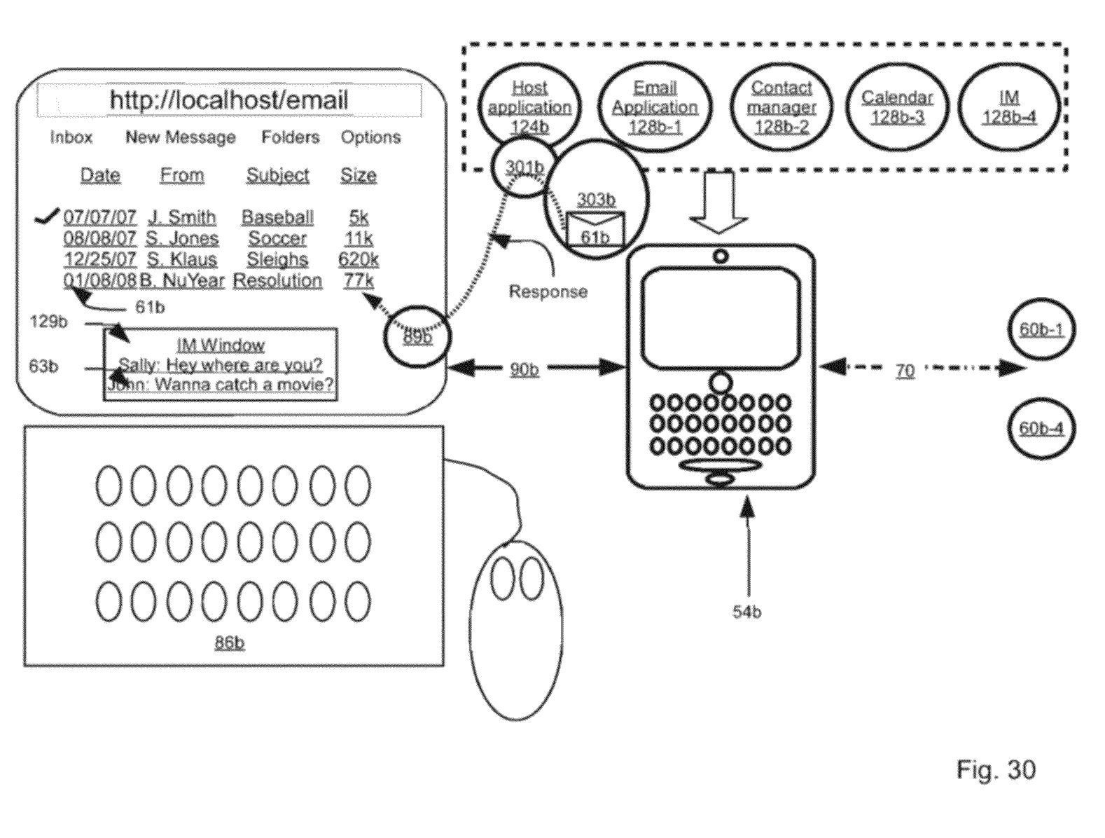

FIG. 30 contemplates a response from module 301b. The response may correspond to block 730b, block 730c or block 730d, depending on the choice of implementation. The response comprises, in the example of FIG. 30, the delivery of email 61b to request module 89b. Email 61b is then generated within the email inbox, and is shown, by way of example, as reading “Jan. 8, 2008 B. NuYear Resolution 77k”.

Those skilled in the art will now appreciate that the foregoing example is illustrative and non-limiting and that in general provision is made for the asynchronous receipt of events at client device 54b and delivery thereof to client machine 86b, while appearing to provide an appearance of a push to client machine 86b.

The foregoing provides various novel systems, apparatuses, and methods for distributing notifications across a plurality of computers. Of note is that various aspects of this specification provide for the appearance of a pushing of notifications to a client machine that is connected to a computing device which in turn is connected to one or more servers.

Other variations, combinations, and subsets will be apparent to those skilled in the art.

1. A method in a mobile device, the method comprising:
establishing communication between the mobile device and a computing machine, the mobile device further connectable to a server application;
receiving, at the mobile device, notifications from the server application;
maintaining a queue of said notifications at the mobile device;
receiving, at the mobile device from the computing machine, a request for any notifications that have been received by the mobile device from the server application, wherein the request indicates a plurality of requested data types;
sending said notifications in the queue to the computing machine as a response to the request;
receiving, at the mobile device, additional notifications from the server application after sending the response and prior to receiving a subsequent request; and
queuing, for a period of time, said additional notifications prior to receiving the subsequent request from the computing machine for said additional notifications.

2. The method of claim 1, wherein the request is a first request including an identifier and a second request received after the first request includes the identifier.

3. The method of claim 1, wherein the request comprises a hypertext transfer protocol (HTTP) request.

4. The method of claim 3, wherein the request comprises an asynchronous JavaScript and eXtensible Markup Language (AJAX) request.

5. The method of claim 1, further comprising determining that the queue is inactive after the period of time.

6. The method of claim 5, further comprising upon determining that the queue is inactive, removing the queue from a list of queues maintained in memory of the mobile device.

7. The method of claim 1, further comprising determining that the queue is active when a request for notifications has not been fulfilled.

8. The method of claim 1, wherein the mobile device is configured to host a client application that receives notifications from the server application.

9. The method of claim 1, wherein the communication between the mobile device and a computing machine comprises a direct connection.

10. The method of claim 1, wherein sending said notifications comprises sending all notifications in the queue

11. The method of claim 10, wherein sending said notifications comprises sending notifications such that the queue becomes empty.

12. The method of claim 1, wherein the queue includes only notifications from the server application.

13. A mobile device comprising:
a network interface to establish communication between the mobile device and a computing machine, the mobile device further connectable to a server application;
an application receiving notifications from the server application;
a queue; and
a queue manager maintaining a queue of the notifications at the mobile device, the queue manager:
receiving, at the mobile device from the computing machine, a request for any notifications that have been received by the mobile device from the server application, wherein the request indicates a plurality of requested data types;
sending said notifications in the queue to the computing machine as a response to the request;
receiving, at the mobile device, additional notifications from the server application after sending the response and prior to receiving a subsequent request; and
queuing, for a period of time, said additional notifications prior to receiving the subsequent request from the computing machine for said additional notifications.

14. The mobile device of claim 13, wherein the request is a first request including an identifier and a second request received after the first request includes the identifier.

15. The mobile device of claim 13, wherein the request comprises a hypertext transfer protocol (HTTP) request.

16. The mobile device of claim 15, wherein the request comprises an asynchronous JavaScript and eXtensible Markup Language (AJAX) request.

17. The mobile device of claim 13, further comprising determining that the queue is inactive after the period of time.

18. The mobile device of claim 17, further comprising upon determining that the queue is inactive, removing the queue from a list of queues maintained in memory of the mobile device.

19. The mobile device of claim 13, further comprising determining that the queue is active when a request for notifications has not been fulfilled.

20. The mobile device of claim 13, further comprising a client application that receives notifications from the server application.

21. The mobile device of claim 13, wherein the communication between the mobile device and a computing machine comprises a direct connection.

22. The mobile device of claim 13, wherein sending said notifications comprises sending all notifications in the queue.

23. The mobile device of claim 22, wherein sending said notifications comprises sending notifications such that the queue becomes empty.

24. The mobile device of claim 13, wherein the queue includes only notifications from the server application.
